(19) United States
(12) Patent Application Publication
(10) Pub. No.: US 2025/0286637 A1
(43) Pub. Date: Sep. 11, 2025

(54) SIGNAL TRANSMISSION METHOD, APPARATUS, AND COMMUNICATION DEVICE

(71) Applicant: VIVO MOBILE COMMUNICATION CO., LTD., Dongguan (CN)

(72) Inventors: Shengli DING, Dongguan (CN); Jianming WU, Dongguan (CN)

(21) Appl. No.: 19/217,072

(22) Filed: May 23, 2025

Related U.S. Application Data
(63) Continuation of application No. PCT/CN2023/133103, filed on Nov. 22, 2023.

(30) Foreign Application Priority Data
Nov. 24, 2022 (CN) 202211486094.9

(51) Int. Cl. H04B 17/364; H04W 72/0446; H04W 72/0453; H04W 72/51

(52) U.S. Cl. CPC H04B 17/364; H04W 72/0446; H04W 72/0453; H04W 72/51

(57) ABSTRACT

A signal transmission method is described. A first device receives parameter configuration information of a first signal, where the first signal is an integrated sensing and communication signal or a sensing signal, a resource pattern of the first signal meets a first feature, and the first feature is: including a target resource, where the target resource includes M target resource units in target domain, the target resource corresponds to at least two resource intervals in target domain, and the target resource unit is a resource unit allocated to the first signal; and the M target resource units in target domain include N target resource unit groups, each target resource unit group includes two adjacent target resource units in target domain in the M target resource units.

### CROSS-REFERENCE TO RELATED APPLICATIONS

This application is a bypass continuation application of International Application No. PCT/CN2023/133103, filed on Nov. 22, 2023, which claims the benefit of and priority to Chinese Patent Application No. 202211486094.9, filed on Nov. 24, 2022, both of which being incorporated by reference in their entireties herein.

### TECHNICAL FIELD

This application relates to the field of communications technologies and, more specifically, relates to a signal transmission method and apparatus, and a communication device.

### BACKGROUND

Future mobile communication systems, such as Beyond 5th Generation (B5G) or 6th Generation (6G) systems, include sensing capabilities in addition to traditional communication functions. These sensing capabilities enable one or more devices to transmit and receive wireless signals in order to determine information such as the direction, distance, and speed of a target object. Devices may also use these signals to detect, track, identify, or image a target objects, events, environments, or the like.

### BRIEF SUMMARY

Embodiments of this application provide a signal transmission method and apparatus and a communication device.

According to a first aspect, an embodiment of this application provides a signal transmission method, including:

A first device receives parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

According to a second aspect, an embodiment of this application provides a signal transmission method, including:

A second device sends parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

According to a third aspect, an embodiment of this application provides a signal transmission apparatus, applied to a first device, and the apparatus includes:

a first receiving module, configured to receive parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

According to a fourth aspect, an embodiment of this application provides a signal transmission apparatus, applied to a second device, and the apparatus includes:

a first sending module, configured to send parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

According to a fifth aspect, an embodiment of this application provides a terminal (a first device). The terminal includes a processor and a memory, the memory stores a program or an instruction that is executable on the processor, and the program or the instruction is executed by the processor to implement the steps of the method according to the first aspect.

According to a sixth aspect, an embodiment of this application provides a terminal (a first device), including a processor and a communication interface. The communication interface is configured to receive parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

According to a seventh aspect, an embodiment of this application provides a network side device (a first device or a second device). The network side device includes a processor and a memory, the memory stores a program or an instruction that is executable on the processor, and the program or the instruction is executed by the processor to implement the steps of the method according to the first aspect or the second aspect.

According to an eighth aspect, an embodiment of this application provides a network side device (a first device or a second device), including a processor and a communication interface. The communication interface is configured to receive or send parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

According to a ninth aspect, an embodiment of this application provides a signal transmission system, including a first device and a second device. The first device may be configured to perform the steps of the method according to the first aspect, and the second device may be configured to perform the steps of the method according to the second aspect.

According to a tenth aspect, an embodiment of this application provides a readable storage medium. The readable storage medium stores a program or an instruction, and when the program or the instruction is executed by a processor, the steps of the method according to the first aspect are implemented, or the steps of the method according to the second aspect are implemented.

According to an eleventh aspect, an embodiment of this application provides a chip. The chip includes a processor and a communication interface, the communication interface is coupled to the processor, and the processor is configured to run a program or instructions, to implement the method according to the first aspect or the method according to the second aspect.

According to a twelfth aspect, an embodiment of this application provides a computer program/program product. The computer program/program product is stored in a storage medium, and the computer program/program product is executed by at least one processor to implement the steps of the method according to the first aspect or implement the steps of the method according to the second aspect.

### BRIEF DESCRIPTION OF DRAWINGS

FIG. 1 is a structural diagram of a communication system to which embodiments of this application may be applied;

FIG. 2 is a first schematic flowchart of a signal transmission method according to an embodiment of this application;

FIG. 3 is a first schematic diagram of a mapping relationship between a first signal and a resource set according to an embodiment of this application;

FIG. 4 is a second schematic diagram of a mapping relationship between a first signal and a resource set according to an embodiment of this application;

FIG. 5 is a schematic diagram of comparison between resource overheads of completely non-uniform signals used in this application and resource overheads of existing equivalent uniformly distributed signals;

FIG. 6 is a first schematic diagram of a resource of a first signal according to an embodiment of this application;

FIG. 7 is a second schematic diagram of a resource of a first signal according to an embodiment of this application;

FIG. 8 is a third schematic diagram of a resource of a first signal according to an embodiment of this application;

FIG. 9 is a first schematic diagram of resources of first signals at different ports according to an embodiment of this application;

FIG. 10 is a second schematic diagram of resources of first signals at different ports according to an embodiment of this application;

FIG. 11 is a third schematic diagram of resources of first signals at different ports according to an embodiment of this application;

FIG. 12 is a fourth schematic diagram of a resource of a first signal according to an embodiment of this application;

FIG. 13 is a fifth schematic diagram of a resource of a first signal according to an embodiment of this application;

FIG. 14 is a second schematic flowchart of a signal transmission method according to an embodiment of this application;

FIG. 15 is a third schematic flowchart of a signal transmission method according to an embodiment of this application;

FIG. 16 is a first schematic diagram of a module of a signal transmission apparatus according to an embodiment of this application;

FIG. 17 is a second schematic diagram of a module of a signal transmission apparatus according to an embodiment of this application;

FIG. 18 is a structural block diagram of a communication device according to an embodiment of this application;

FIG. 19 is a structural block diagram of a terminal according to an embodiment of this application;

FIG. 20 is a first structural block diagram of a network side device according to an embodiment of this application; and

FIG. 21 is a second structural block diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to applications other than the NR system application, such as a 6^{th} Generation (6G) communication system.

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station a Wireless Local Area Network (WLAN) access node, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

To enable a person skilled in the art to better understand the embodiments of this application, the following descriptions are provided first.

### 1. Integrated Sensing and Communication or ISAC

Future B5G and 6G wireless communication systems are expected to provide a variety of high-precision sensing services, such as indoor positioning for robot navigation, Wi-Fi sensing for smart homes, and radar sensing for autonomous driving vehicles. Sensing and communication systems are often designed separately and occupy different frequency bands. Then, due to widespread deployment of millimeter wave and massive Multiple Input Multiple Output (MIMO) technologies, a communication signal in a future wireless communication system tends to have a high resolution in time domain and angle domain, which makes it possible to realize high-precision sensing by using the communication signal. Therefore, it is better to jointly design sensing and communication systems, so that the sensing and communication systems can share a same frequency band and hardware to improve frequency efficiency and reduce hardware costs. This has led to study on Integrated Sensing And Communication (ISAC). ISAC is to become a key technology in the future wireless communication system to support many important application scenarios. For example, in a future network of autonomous driving vehicles, an autonomous driving vehicle obtains a large amount of information from the network, including an ultra-high-resolution map and near-real-time information to perform navigation and avoid an upcoming traffic jam. In a same case, a radar sensor in the autonomous driving vehicle should be able to provide robust, high-resolution obstacle detection function with a resolution in an order of centimeters. The ISAC technology for the autonomous driving vehicle offers a possibility of high-data-rate communication and high-resolution obstacle detection by using same hardware and spectrum resources. Other applications for ISAC include Wi-Fi-based indoor positioning and activity recognition, communications and sensing for unmanned aircraft, Extended Reality (XR), integrated radar and communication, and the like. Each application has a different requirement, restriction, and regulatory issue. ISAC has generated significant research interest and attention from the academia and the industry. For example, recently there has been a growing number of academic publications on ISAC, ranging from transceiver architecture design, ISAC waveform design, joint coding design, time-frequency-space signal processing, to experimental performance delay, prototype design, and field testing.

ISAC provides low-cost implementation for integration of communication and sensing functions in a manner of hardware device sharing and a software-defined function and mainly has the following features: first, a unified and simplified architecture; second, a reconfigurable and scalable function; and third, improved efficiency and reduced costs. Advantages of integrated sensing and communication are mainly in three aspects: first, costs and a size of a device are reduced; second, spectrum utilization is improved; and third, system performance is improved.

The academia usually divides development of ISAC into four stages: co-existence, co-operation, co-design, and co-collaboration.

Co-existence: Communication and sensing are two separate systems and interfere with each other, and main methods to avoid the interference are: distance isolation, frequency band isolation, time division work, MIMO technology, pre-coding, and the like.

Co-operation: Communication and sensing share a hardware platform and use common information to improve common performance, power distribution between communication and sensing has a great impact on system performance, and main problems are: low signal-to-noise ratio, mutual interference, low throughput.

Co-design: Communication and sensing become a complete joint system, including joint signal design, waveform design, coding design, and the like. Initially, there is a linear frequency modulation waveform, a spread spectrum waveform, and the like. Later, the focus shifts to an Orthogonal Frequency Division Multiplexing (OFDM) waveform, a MIMO technology, and the like.

Co-collaboration: A plurality of integrated sensing and communication nodes collaborate to achieve a common goal. For example, radar detection information is shared through communication data transmission, and typical scenarios include a driver assistance system, a radar assistance communication, and the like.

At present, typical integrated sensing and communication scenarios that are expected to be realized through technology upgrade according to a 5G communication system architecture are shown in Table 1.

TABLE 1

| Wireless sensing | | |
|---|---|---|
| category | Sensing function | Application scenario |
| Large-scale | Weather, air quality, | Meteorology, agriculture, |
| macro-sensing | and the like | and life services |
| category | Traffic flow (intersections) | Smart city, intelligent |
| | and flow of people | transportation, and |
| | (subway entrances) | business services |
| | Animal activities, | Animal husbandry, |
| | migration, and the like | ecological environment |
| | | protection, and the like |
| | Target tracking, ranging, | Many application |
| | speed measurement, | scenarios for |
| | contours, and the like | conventional radar |
| | Three-dimensional map | Intelligent driving, |
| | construction | navigation, and smart |
| | | city |
| Short-distance | Action posture | Intelligent interaction of |
| refined-sensing | recognition | smartphones, games, and |
| category | | smart home |
| | Heartbeat, breathing, | Health and medical care |
| | and the like | |
| | Imaging, material | Security check, industry, |
| | detection, and the like | and the like. |

### 2. Radar Technology

Radar (Radio Detection and Ranging, Radar) means “radio detection and ranging”, is to discover a target and measure a distance of the target by transmitting a radio wave and receiving a reflected echo of the target. With the development of the radar technology, a radar detection target is not only a distance of a measured target, but also a speed, an azimuth, and a pitch angle of the measured target, and more information about the target, including a size and a shape of the target, is extracted from the foregoing information.

The radar technology is originally used for military purposes to detect an aircraft, a missile, a vehicle, a ship, and other targets. With the development of the technology and the evolution of society, radar is more used in civil scenarios. A typical application is that weather radar measures an echo of a meteorological target such as clouds and rain to determine information such as a position and intensity of clouds and rain for weather forecasting. Further, with the vigorous development of the electronic information industry, the Internet of Things, the communication technology, and the like, the radar technology has begun to enter daily life applications of people, thereby greatly improving convenience and safety of work and life, and the like. For example, vehicle radar provides warning information for vehicle driving by measuring a distance and a relative speed between vehicles, between the vehicle and a surrounding environment, between the vehicle and a pedestrian, and the like, thereby greatly improving a safety level of road traffic.

At a technical level, radar can be classified in many ways. According to a position relationship between radar transmitting and receiving stations, there is single-station radar and dual-station radar, as shown in the figure below. For the single-station radar, a signal transmitter and receiver are integrated and share an antenna. An advantage is that a target echo signal and a local oscillator of the receiver are naturally coherent, and signal processing is convenient. A disadvantage is that signal transmitting and receiving cannot be performed at the same time, and only a signal waveform with a specific duty cycle can be used, which brings a detection blind zone that needs to be compensated by using a complex algorithm; or signal transmitting and receiving are performed at the same time, transmitting and receiving are strictly isolated, but it is difficult to achieve for high-power military radar. For the dual-station radar, a signal transmitter and receiver are in different positions. An advantage is that signal transmitting and receiving can be performed at the same time, and a waveform of a continuous wave can be used for detection. A disadvantage is that it is difficult to achieve intra-frequency and coherence between the receiver and the transmitter, and signal processing is complex.

In a wireless sensing application of integrated sensing and communication, the radar technology may use a single-station radar mode or a dual-station radar mode.

In the single-station radar mode, signal transmitting and receiving share an antenna, and a received signal and a transmitted signal enter different radio frequency processing links through a circulator. In the mode, a continuous wave signal waveform can be used to achieve detection without the blind zone on the premise that the received signal and the transmitted signal need to be well isolated, usually about isolation of 100 dB, to eliminate masking of the received signal due to leakage of the transmitted signal. Because the receiver of the single-station radar has all information of the transmitted signal, the signal can be processed through matched filtering (pulse compression) to obtain a higher signal processing gain.

In the dual-station radar mode, there is no isolation problem of the received signal and the transmitted signal, which greatly simplifies hardware complexity. Because radar signal processing is founded based on known information, in 5G NR integrated sensing and communication application, a radar signal may be processed by using known information such as a synchronization signal (a Primary Synchronization Signal (PSS)/Secondary Synchronization Signal (SSS)), and a reference signal (a Demodulation Reference Signal (DMRS)/Channel State Information-Reference Signal, (CSI-RS). However, due to a periodicity of the synchronization signal, the reference signal, and the like, an ambiguity map of a signal waveform is no longer in a thumbtack shape but a pin cushion shape. As a result, ambiguity degrees of a delay and Doppler increase, and a gain of a main lobe is much lower than that of the single-station radar mode, reducing a measurement range of a distance and a speed. With the appropriate parameter set design, the measurement range of the distance and the speed can meet a measurement requirement for a common target such as a vehicle or a pedestrian. In addition, measurement accuracy of the dual-station radar is related to positions of a transmitting station and a receiving station relative to a target, and therefore it is necessary to select the appropriate transmitting station and the appropriate receiving station to improve detection performance.

### 3. Conventional Uniform Distribution of Sensing Signals

A requirement for a resource configuration of a sensing signal is investigated under a condition of a given sensing requirement.

The sensing requirement includes a requirement for a resolution of a target parameter and/or a requirement for a maximum unambiguous measurement range. The target parameter includes: a delay or a distance, Doppler or a speed, and an angle.

A resource is a resource in target domain that corresponds to the target parameter. The target domain and the resource in target domain include:

1: a time domain: a time resource, including: an Orthogonal Frequency Division Multiplexing (OFDM) symbol, a slot, a sub-frame, a frame, and the like;

2: a frequency domain: a frequency resource, including: a subcarrier, a Resource Block (RB), and the like; and

3: a space domain: an antenna or a port resource.

The sensing requirement for the resource configuration mainly includes two aspects:

1: Resource span: In target domain, a span between a minimum resource unit index and a maximum resource unit index in a resource of a sensing frame includes: duration (time domain), a bandwidth (frequency domain), an aperture (space dimension).

2: Resource unit interval: In target domain, an interval between adjacent target resource units in target domain within a sensing frame includes: an interval between OFDM symbols allocated to a sensing signal (time domain), an interval between subcarriers allocated to the sensing signal (frequency domain), and an interval between antennas or ports allocated to the sensing signal (space domain).

Effects of the resource configuration on sensing include as follows:

1: The resource span determines a resolution of the target parameter, including: A time span in time domain determines a measurement resolution of the Doppler or the speed, a bandwidth in frequency domain determines a measurement resolution of the delay or the distance, and the aperture in space domain determines a measurement resolution of the angle.

2: The target resource unit interval determines a maximum unambiguous measurement range of the target parameter, including: The interval between the OFDM symbols allocated to the sensing signal in time domain determines a maximum unambiguous measurement range of the Doppler or the speed, the interval between the subcarriers allocated to the sensing signal in frequency domain determines a maximum unambiguous measurement range of the delay or the distance, and the interval between the antennas or the ports allocated to the sensing signal in space domain determines a maximum unambiguous measurement range of the angle.

A relationship between the resource configuration of the sensing signal and the sensing requirement is discussed below mainly in the time domain resource configuration and the frequency domain resource configuration.

### 1: Delay/Distance

Delay information is directly obtained when sensing is performed using an electromagnetic wave, and a distance is obtained through conversion of a delay. Therefore, a relationship between the delay and the resource configuration of the sensing signal is mainly discussed herein.

A resolution of the delay is given by the following formula:

$$Δ τ = \frac{1}{B}$$

B indicates a signal bandwidth.

A maximum unambiguous measurement range of the delay is given by the following formula:

$${τ}_{max} = \frac{1}{Δ f}$$

Δf represents an interval between adjacent subcarriers allocated to a sensing signal.

### 2: Doppler/Speed

Doppler information is directly obtained when sensing is performed using an electromagnetic wave, and a speed is obtained through conversion of Doppler. Therefore, a relationship between the Doppler and the resource configuration of the sensing signal is mainly discussed herein.

A resolution of the Doppler is given by the following formula:

$$Δ {f}_{d} = \frac{1}{T}$$

T is duration of one sensing frame.

A maximum unambiguous measurement range of the Doppler is given by the following formula:

$${f}_{d , max} = \frac{1}{Δ t}$$

Δt represents an interval between adjacent OFDM symbols allocated to a sensing signal.

According to the above analysis, when the resolution of the delay, the resolution of the Doppler, the maximum unambiguous measurement range of the delay, and the maximum unambiguous measurement range of the Doppler are given in the sensing requirement, that is, after Δτ, τₘₐₓ, Δf_{d}, and f_{d,max}, a quantity of required sensing resources is as follows:

1: A quantity of subcarriers is:

$${N}_{s c s} = \frac{B}{Δ f} = \frac{{τ}_{max}}{Δ τ} ;$$

and

a quantity of OFDM symbols is:

$${N}_{symbol} = \frac{T}{Δ t} = \frac{{f}_{d , max}}{Δ {f}_{d}} .$$

The following describes a requirement for the sensing signal for the sensing resource (the subcarrier and the OFDM symbol) in combination with a typical scenario. In a scenario of considering traffic monitoring,

a maximum unambiguous ranging range is 200 m;

a ranging resolution is 0.2 m;

a speed measurement range is −180 km/h to 180 km/h (which can detect a speeding vehicle, including both approaching and receding directions); and

a speed measurement resolution is 0.2 m/s (which can distinguish between slowly walking pedestrians).

Considering that a carrier center frequency is a millimeter wave frequency band of 30 GHz, a corresponding sensing resource configuration requirement meets the following conditions:

a bandwidth is B≥750 MHZ;

an interval between adjacent subcarriers allocated to a sensing signal is Δf≤1500 kHz;

duration of a sensing frame is T≥25 ms; and

an interval between adjacent OFDM symbols allocated to the sensing signal is Δt≤50 μs

According to the above analysis, in the traffic monitoring scenario given herein, a quantity of required sensing resources is:

a quantity of subcarriers is N_{SCS}≥500; and

a quantity of OFDM symbols is N_{symbol}≥500.

It can be learned that to meet the sensing requirement for the above traffic monitoring scenario, overheads of time-frequency domain resources are high. A proportion of the overheads of time-frequency domain resources in entire time-frequency domain is further investigated. In a case of 30 GHz center frequency, considering a subcarrier spacing of 120 kHz, duration of the OFDM symbol is 8.33 μs. To meet the above resource configuration requirement, it is necessary to allocate 1 subcarrier in every 12 subcarriers to the sensing signal and allocate 1 OFDM symbol in every 6 OFDM symbols to the sensing signal. In a multi-port sensing scenario, a proportion of overheads of the sensing resource is further increased.

In an integrated sensing and communication scenario, conventional uniform distribution for a sensing signal resource configuration has the following three problems:

First, to meet a sensing requirement (a resolution or a maximum unambiguous measurement range), high resource overheads of the sensing signal are required.

Second, in a communication system, because various communication reference signals (such as a CSI-RS, a DMRS, a Phase-Tracking Reference Signal (PTRS), and the like) occupy a large number of time-frequency domain grids, in many cases, it is difficult to find continuous large-span (large-bandwidth, large-time width) uniformly distributed time-frequency domain resource grids to meet the sensing requirement.

Third, how to combine the existing various communication reference signals for sensing to reduce overheads of the time-frequency domain resources of the sensing signal is to be resolved.

The following describes in detail a signal transmission method provided in the embodiments of this application by using some embodiments and application scenarios thereof with reference to the accompanying drawings.

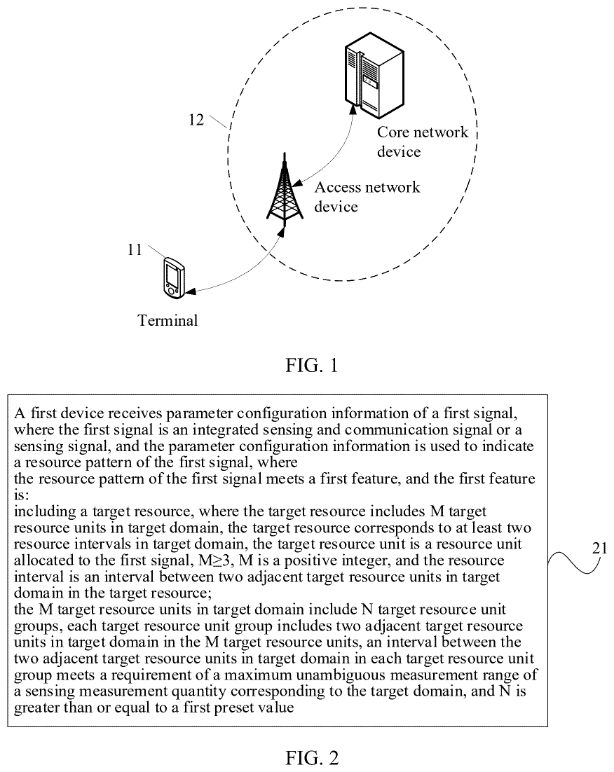

As shown in FIG. 2, an embodiment of this application provides a signal transmission method, including the following steps.

Step 21: A first device receives parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

Optionally, there may be or may not be an intersection between the above target resource unit groups. For example, a target resource unit group includes a 1^{st} target resource unit and a 2^{nd} target resource unit in M target resource units, and another target resource unit group includes the 2^{nd} target resource unit and a 3^{rd} target resource unit in the M target resource units.

In a possible implementation, the first preset value may be determined according to the requirement for the maximum unambiguous measurement range of the sensing measurement quantity corresponding to the target domain.

Optionally, in a case that the target domain is a time domain, a sensing measurement quantity corresponding to the time domain includes Doppler or a speed, and in a case that the target domain is a frequency domain, a sensing measurement quantity corresponding to the frequency domain includes a delay or a distance.

In this step, the first device obtains the parameter configuration information, of the first signal, sent by the second device, the first device includes but is not limited to a terminal or a base station, and the second device includes but is not limited to a base station or a core network device.

The resource unit includes at least one of a time domain resource unit and a frequency domain resource unit, the time domain resource unit includes but is not limited to an OFDM symbol, and the frequency domain resource unit includes but is not limited to a subcarrier. That is, the target resource unit may be at least one of a target OFDM symbol and a target subcarrier. An OFDM symbol allocated to the first signal is referred to as the target OFDM symbol, and a subcarrier allocated to the first signal is referred to as the target subcarrier.

In this embodiment of this application, the first device receives the parameter configuration information of the first signal, where the first signal is the integrated sensing and communication signal or the sensing signal, the resource pattern of the first signal meets the first feature, and the first feature is: including the target resource, where the target resource includes the M target resource units in target domain, the target resource corresponds to the at least two resource intervals in target domain, and the target resource unit is the resource unit allocated to the first signal; and the M target resource units in target domain include the N target resource unit groups, each target resource unit group includes the two adjacent target resource units in target domain in the M target resource units, and the interval between the two adjacent target resource units in target domain in each target resource unit group meets the requirement for the maximum unambiguous measurement range of the sensing measurement quantity corresponding to the target domain. The M target resource units correspond to the at least two resource intervals in target domain, and in the integrated sensing and communication scenario, according to the sensing requirement, a resource interval between some adjacent target resource units in target domain can be set as a resource interval meeting a resolution requirement for a corresponding sensing measurement quantity, while a resource interval between remaining adjacent target resource units in target domain is greater than the resource interval of the resolution requirement for the corresponding sensing measurement quantity. Therefore, resource overheads are reduced on the premise that the first signal can meet the sensing requirement.

Optionally, the target domain includes the time domain, and an interval between two adjacent target resource units in time domain in each resource unit group meets a requirement for a maximum unambiguous measurement range of the Doppler or the speed.

In an embodiment of this application, assuming that an interval between two adjacent target resource units in time domain in any target resource unit group is ΔT, ΔT≤1/f_{d,max} or ΔT≤c/2f_{c}vₘₐₓ should be met, where f_{d,max} represents a maximum unambiguous measurement value of the Doppler, c represents the speed of light, f_{c} represents a carrier center frequency, and vₘₐₓ represents a maximum unambiguous measurement value of the speed.

The maximum unambiguous measurement value of the Doppler or the maximum unambiguous measurement value of the speed is determined according to a sensing requirement or sensing prior information, including one of the following:

When a direction of the Doppler or the speed is known, a relationship between the maximum unambiguous measurement value of the Doppler or the speed and maximum Doppler f_{d,max}⁰ or a maximum speed vₘₐₓ⁰ of a target in the sensing prior information or the sensing requirement is: f_{d,max}=|f_{d,max}⁰| or vₘₐₓ=|vₘₐₓ⁰|.

When a direction of the Doppler or the speed is unknown, a relationship between the maximum unambiguous measurement value of the Doppler or the speed and maximum Doppler f_{d,max}⁰ or a maximum speed vₘₐₓ^{D} of a target in the sensing prior information or the sensing requirement is: f_{d,max}=2|f_{d,max}⁰| or vₘₐₓ=2|vₘₐₓ⁰|.

It should be noted that ΔT may have one or more values, and a quantity of target OFDM symbols corresponding to the N target resource unit groups should not be less than a preset quantity. For example, values of a time interval between adjacent target OFDM symbols in the M target OFDM symbols are arranged in ascending order, including {ΔT₁,ΔT₂,ΔT₃, . . . ΔTₙ} and corresponding quantities of target OFDM symbols are respectively {N₁,N₂,N₃, . . . Nₙ}. Then, Σᵢ₌₁^{t}Nᵢ should be not less than the preset value, where t is a subscript of a maximum value meeting the condition ΔT≤1/f_{d,max} or ΔT≤c/2f_{c}vₘₐₓ in the sequence {ΔT₁,ΔT₂,ΔT₃, . . . ΔTₙ} that is, ΔTₜ meets the condition ΔT≤1/f_{d,max} or ΔT≤c/2f_{c}vₘₐₓ but ΔTₜ₊₁ does not meet the condition.

Optionally, the target domain includes the frequency domain, and an interval between two adjacent target resource units in frequency domain in each resource unit group meets a requirement for a maximum unambiguous measurement range of the delay or the distance.

In an embodiment of this application, assuming that an interval between two adjacent target resource units in frequency domain in any target resource unit group is Δf, Δf≤1/τₘₐₓ or Δf≤c/2Rₘₐₓ is met, where τₘₐₓ represents a maximum unambiguous measurement value of the delay, c represents the speed of light, and Rₘₐₓ represents a maximum unambiguous measurement value of the distance in the sensing requirement.

Similarly, Δ_{f} may have one or more values, and a quantity of target subcarriers corresponding to the N target resource unit groups is not less than a preset quantity.

Optionally, a resource span of the M target resource units in target domain meets a resolution requirement for the sensing measurement quantity corresponding to the target domain.

Optionally, the target domain includes the time domain, and a resource span of the M target resource units in time domain meets a resolution requirement for the Doppler or the speed.

The resource span of the M target resource units in time domain means total duration T between a target OFDM symbol with a minimum index and a target OFDM symbol with a maximum index in time domain, including duration occupied by an OFDM symbol that is not allocated to the first signal between the target OFDM symbol with the minimum index and the target OFDM symbol with the maximum index in time domain.

The total duration T of the first signal (usually referred to as a sensing frame length, or coherence processing time, to represent a length of the first signal in time domain to perform one time of coherent signal processing and obtain the sensing measurement quantity or a sensing result) meets: T≥1/Δf_{d} or T≥c/2f_{c}Δv, where Δf_{d} represents a resolution of the Doppler in the sensing requirement, c represents the speed of light, f_{c} represents the carrier center frequency, and Δv represents a resolution of the speed in the sensing requirement.

Optionally, the target domain includes the frequency domain, and a resource span of the M target resource units in frequency domain meets a resolution requirement for the delay or the distance.

The resource span of the M target resource units in frequency domain means a total bandwidth B between a target subcarrier with a minimum index and a target subcarrier with a maximum index in frequency domain, including a bandwidth occupied by a subcarrier that is not allocated to the first signal between the target subcarrier with the minimum index and the target subcarrier with the maximum index in frequency domain.

The total bandwidth B of the first signal is: B≥1/Δτ or B≥c/2ΔR where Δτ represents a resolution of the delay in the sensing requirement, c represents the speed of light, and ΔR represents a resolution of the distance in the sensing requirement.

Optionally, the target domain includes the time domain, and a ratio of a first parameter of a first side lobe to a first parameter of a main lobe of a time domain signal sequence of the first signal in first transform domain is less than a first preset threshold; and/or

the target domain includes the frequency domain, and a ratio of a second parameter of a second side lobe to a second parameter of a main lobe of a frequency domain signal sequence of the first signal in second transform domain is less than a second preset threshold, where

the first transform domain is a Doppler domain, the first side lobe is a side lobe with a maximum amplitude or power in Doppler domain, and the first parameter includes an amplitude or a power; and

the second transform domain is a delay domain, the second side lobe is a side lobe with a maximum amplitude or power in delay domain, and the second parameter includes an amplitude or a power.

The parameter configuration information of the first signal in this application embodiment may also be described as completely non-uniform signal configuration information, that is, completely non-uniform signal configuration is performed on the first signal.

The resource configuration of the first signal is described below in detail with reference to a specific embodiment.

In an embodiment of this application, completely non-uniform signal configuration in this application is performed on the first signal in time domain, that is, the target OFDM symbols allocated to the first signal correspond to at least two resource intervals, and distribution of the first signal in frequency domain is not limited herein. In some embodiments, the subcarriers allocated to the first signal are arranged in regular uniform distribution in frequency domain. For example, a k^{th} subcarrier in each RB within a bandwidth part (Bandwidth Part, BWP) in which the first signal is located is allocated to the first signal, where k is a subcarrier number in the RB.

The distribution of the first signal in time domain uses the scheme described in this application. Specifically, a position of the OFDM symbol allocated to the first signal in time domain is described by: a system frame number n_{f}, a half-frame number, a subframe number, a slot number nₛ^{μ} or n_{s,f}^{μ}, and an OFDM symbol number 1 in the slot.

The first signal has the following features in time domain:

Feature T1: The M target OFDM symbols allocated to the first signal are non-uniformly distributed in time domain, that is, the M target OFDM symbols correspond to at least two resource intervals in time domain.

Feature T2: The total duration occupied by all the OFDM symbols allocated to the first signal meets the resolution requirement for the Doppler or the speed.

Feature T3: The M target OFDM symbols include N target OFDM symbol groups, each target OFDM symbol group includes two adjacent target OFDM symbols in time domain in the M target OFDM symbols, and an interval between the two adjacent target OFDM symbols in time domain in each target OFDM symbol group meets a requirement for a maximum unambiguous measurement range of the Doppler or the speed corresponding to the time domain.

Feature T4: After a time domain signal sequence of the first signal is transformed into a Doppler domain, a ratio of a first parameter in Doppler domain to a first parameter of a main lobe is less than a first preset threshold, and the first parameter includes an amplitude or a power.

In an embodiment of this application, the first signal is completely non-uniformly distributed in frequency domain, and it should be emphasized that a configuration of the first signal in an active BWP is considered herein. The distribution of the first signal in time domain is not limited herein. In some embodiments, the OFDM symbols allocated to the first signal are arranged in regular uniform distribution in time domain. For example, an l₀ₜₕ OFDM symbol and/or an l₁ₜₕ OFDM symbol in a slot meeting (Nₛₗₒₜ^{frame,μ}n_{f}+n_{s,f}^{μ}−T_{offset})modT_{CSI-RS}=0 are/is allocated to the first signal, where Nₛₗₒₜ^{frame,μ} is a quantity of slots included in a system frame, n_{f} is a system frame number, n_{s,f}^{μ} is a slot number in a system frame, T_{offset} is a slot offset in a periodicity, T_{CSI-RS} is a periodicity in a unit of a slot, and l₀ and l₁ are OFDM symbol numbers in the slot.

The distribution of the first signal in frequency domain uses the scheme described in this application. Specifically, a position of the target subcarrier allocated to the first signal in frequency domain is described by: an RB number n_{PRB}^{μ} or n_{CRB}^{μ}, and a subcarrier number k in the RB.

The first signal has the following features in frequency domain:

Feature F1: The M target subcarriers allocated to the first signal are non-uniformly distributed in frequency domain, that is, the M target subcarriers correspond to at least two resource intervals in frequency domain.

Feature F2: The total bandwidth occupied by all the subcarriers allocated to the first signal meets the resolution requirement for the delay or the distance.

Feature F3: The M target subcarriers include N target subcarrier groups, each target subcarrier group includes two adjacent target subcarriers in frequency domain in the M target subcarriers, and an interval between the two adjacent target subcarriers in frequency domain in each target subcarrier group meets a requirement for a maximum unambiguous measurement range of the Doppler or the speed corresponding to the frequency domain.

Feature F4: After a frequency domain signal sequence of the first signal is transformed to a delay domain, a ratio of a second parameter of a second side lobe in delay domain to a second parameter of the main lobe is less than a second preset threshold, and the second side lobe is a side lobe with a maximum amplitude or power in delay domain.

In an embodiment of this application, the distribution of the first signal in time domain and frequency domain uses the scheme in this embodiment of this application, and the target OFDM symbol allocated to the first signal meets the above features T1 to T4 in time domain, where a position of the OFDM symbol allocated to the first signal in time domain is described by: a system frame number n_{f}, a half-frame number, a subframe number, a slot number n_{s,f}^{μ}, and an OFDM symbol number 1 in the slot. In addition, the target subcarrier allocated to the first signal meets the above features F1 to F4 in frequency domain, where a position of the target subcarrier allocated to the first signal in frequency domain is described by: an RB number n_{PRB}^{μ} or n_{CRB}^{μ}, and a subcarrier number k in the RB.

Optionally, the parameter configuration information includes resource configuration information of one or more resource sets, each resource set includes at least one target resource unit, and the target resource includes the one or more resource sets.

In a case that the target domain is the time domain, the target OFDM symbols belonging to the first signal are divided into several resource sets, the resource sets may overlap or may not overlap in time domain, and the first signal meeting the feature T1 to the feature T4 is combined in time domain on the resource sets. A parameter configuration of the first signal is performed by using the resource set as a component.

In a case that the target domain is the frequency domain, the target subcarriers belonging to the first signal are divided into several resource sets, the resource sets may overlap or may not overlap in frequency domain, and the first signal meeting the features F1 to F4 is combined in frequency domain on the resource sets. A parameter configuration of the first signal is performed by using the resource set as a component.

In a case that the target domain includes the time domain and the frequency domain, {target OFDM symbols, target subcarriers} belonging to the first signal are divided into several resource sets, the resource sets may overlap or may not overlap in time domain and/or frequency domain, and the first signal combined on the resource sets meets the features T1 to T4 in time domain and meets the features F1 to F4 in frequency domain. A parameter configuration of the first signal is performed by using the resource set as a component.

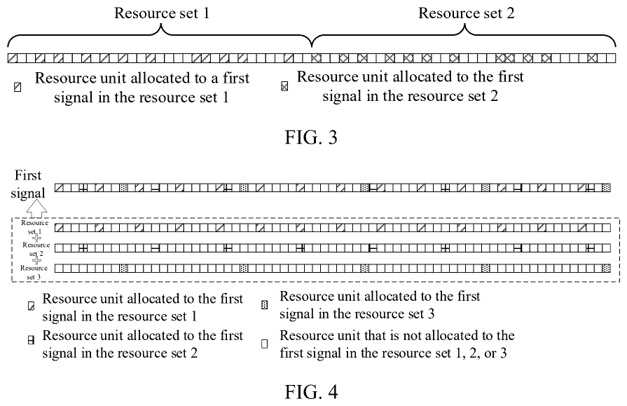

A schematic diagram of the first signal combined on the resource sets is shown in FIG. 3 and FIG. 4. When a parameter configuration meeting the features T1 to T3 or the features F1 to F3 is performed on the first signal, the resource set is used as the component. The first signal includes at least one resource set in time domain or frequency domain, and when a quantity of resource sets is greater than 1, resource sets do not overlap (as shown in FIG. 3) or resource sets overlap (as shown in FIG. 4) in target domain.

Optionally, the resource configuration information of the one or more resource sets includes at least one of the following:

a first item: a start position of the one or more resource sets in target domain;

a second item: a span of the one or more resource sets in target domain;

a third item: a resource interval between target resource units in the one or more resource sets;

a fourth item: a quantity of target resource units in the one or more resource sets;

a fifth item: a density of target resource units in the one or more resource sets;

a sixth item: a repetition periodicity of a slot, in time domain, in which a target resource unit in the one or more resource sets is located;

a seventh item: a position of a target resource unit in a slot in which the target resource unit in the one or more resource sets is located;

an eighth item: a repetition periodicity of a resource block RB, in frequency domain, in which a target resource unit in the one or more resource sets is located;

a ninth item: a position of an RB, in frequency domain, in which a target resource unit in the one or more resource sets is located;

a tenth item: a position, in an RB, of a target resource unit in the one or more resource sets;

an eleventh item: first indication information, where the first indication information is used to indicate that the target domain is the time domain and/or the frequency domain; and

a twelfth item: second indication information, where the second indication information is used to indicate position distribution of target resource units in the one or more resource sets in target domain, where

the span of the resource set in target domain is a span between a 1^{st} resource unit and a last resource unit of the resource set in target domain.

Optionally, the target resource unit includes at least one of a target OFDM symbol and a target subcarrier.

Optionally, for the first item, the start position of the one or more resource sets in target domain includes a start position of the one or more resource sets in time domain and/or a start position of the one or more resource sets in frequency domain. The start position of the one or more resource sets in time domain is indicated by at least one of the frame number, the half-frame number, the subframe number, the slot number, and the OFDM symbol number; or the start position of the one or more resource sets in time domain includes a time offset relative to a start position of the first signal in time domain, where a parameter of the time offset includes at least one of a quantity of frames, a quantity of half-frames, a quantity of subframes, a quantity of slots, and a quantity of OFDM symbols. The start position of the one or more resource sets in frequency domain may be indicated by an offset relative to a preset reference point. The preset reference point may be a point (point) A or a Physical Resource Block (PRB) 0 of a BWP, and the offset may be indicated by at least one of the following: a quantity of resource block groups (RBG), a quantity of RBs, and a quantity of resource elements (RE). The start position of the one or more resource sets in frequency domain may alternatively be indicated by an offset relative to a start position of the first signal in frequency domain. The offset may be indicated by at least one of the following: a quantity of RBGs, a quantity of RBs, and a quantity of REs.

For the second item, the span of the one or more resource sets in target domain includes a resource span of the one or more resource sets in time domain and/or frequency domain. The resource span of the one or more resource sets in time domain may be a span between an OFDM symbol with a maximum index and an OFDM symbol with a minimum index in the resource set in time domain. The resource span of the one or more resource sets in frequency domain may be a span between a subcarrier with a maximum index and a carrier with a minimum index in the resource set in frequency domain.

For the third item, the resource interval between the target resource units in the one or more resource sets includes at least one of a target OFDM symbol interval in the one or more resource sets and a target subcarrier spacing in the one or more resource sets.

For the fourth item, the quantity of target resource units in the one or more resource sets includes at least one of a quantity of target OFDM symbols and a quantity of target subcarriers in the one or more resource sets.

For the fifth item, the density of target resource units in the one or more resource sets includes at least one of a density of target OFDM symbols and a density of target subcarriers in the one or more resource sets. The density of target OFDM symbols in the one or more resource sets means a quantity of target OFDM symbols included in a preset number of consecutive OFDM symbols in time domain, or a ratio of a quantity of target OFDM symbols included in a preset number of consecutive OFDM symbols in time domain to the preset quantity. For example, in time domain, when two symbols are allocated to the first signal in one slot (14 symbols), the density of target OFDM symbols may be represented as 2 or 1/7.

The density of target subcarriers in the one or more resource sets means a quantity of target subcarriers included in a preset quantity of contiguous subcarriers in frequency domain, or a ratio of a quantity of target subcarriers included in a preset quantity of contiguous subcarriers in frequency domain to the preset quantity. For example, in frequency domain, when two subcarriers in one RB (12 subcarriers) are allocated to the first signal, the density of target subcarriers may be represented as 3 or ¼.

For the twelfth item, the second indication is used to indicate position distribution of target OFDM symbols in the one or more resource sets in time domain and/or is used to indicate position distribution of target subcarriers in the one or more resource sets in frequency domain.

Optionally, the second indication information includes at least one of the following:

A1: A bitmap, where the bitmap includes L bits, and each bit corresponds to one resource unit; in a case that a value corresponding to the bit is a first value, the resource unit corresponding to the bit is a target resource unit allocated to the resource set, or in a case that a value corresponding to the bit is a second value, the resource unit corresponding to the bit is not a target resource unit allocated to the resource set; and L is a positive integer.

In this embodiment of this application, the position distribution of target resource units in the one or more resource sets in target domain may be indicated by the bitmap (bitmap), and a bit in the bitmap is used to indicate whether a corresponding resource unit is a target resource unit allocated to the resource set. For example, the bit is 1, to indicate that a resource unit is a target resource unit allocated to the resource set. The bit is 0, to indicate that a resource unit is not a target resource unit allocated to the resource set.

A2: Parameter information of a sub-block, where the parameter information of the sub-block includes at least one of position distribution information of a target resource unit in the sub-block, a quantity X of sub-blocks, a repetition periodicity of the sub-block, and a start position of a 1^{st} sub-block in X sub-blocks, and X is a positive integer.

In an implementation of this application, the position of the target resource unit in the resource set is repeated in a periodicity, the resource set is periodically divided into a preset number of first sub-blocks, and target resource units in the first sub-blocks have same position distribution. In this case, the parameter information of the sub-block may include at least one of position distribution information of the target resource unit in the first sub-block (may be indicated by the bitmap), a quantity X of first sub-blocks, a repetition periodicity of the first sub-block, and a start position of a 1^{st} sub-block in X first sub-blocks, where X is a positive integer.

It should be noted that the periodicity in this implementation is not limited to a time dimension, but also includes a frequency dimension. For example, if a pattern of specific subcarrier distribution is repeated every 10 RBs in the frequency dimension, the periodicity of the frequency dimension is 10 RBs.

In an implementation of this application, the resource set may be divided into a preset number of second sub-blocks, and target resource units in the second sub-blocks have same position distribution, but start positions of the second sub-blocks are not periodic. In this case, the parameter information of the sub-block includes at least one of position distribution information of the target resource unit in the second sub-block (may be indicated by the bitmap), a quantity X of second sub-blocks, and a start position of each of X second sub-blocks, where X is a positive integer.

The start position of the second sub-block may be indicated in the following manners:

The start position of each second sub-block is directly indicated.

The start position of each second sub-block is indicated in a manner of a periodicity+an offset, that is, the start position of each sub-block has an offset relative to a periodic position. In this case, the periodicity and the offset may be used to indicate the start position of each second sub-block.

A3: Parameter information of a target formula, where the target formula is a formula used to calculate position information of the target resource unit in the resource set in target domain, the parameter information of the target formula includes at least one of a type of the target formula, a formula parameter of the target formula, and a calculation result that is obtained according to the target formula, and the calculation result is used to indicate the position information.

In some embodiments of this application, a time domain resource may be represented using a Start and length Indicator Value (SLIV) method, and a frequency domain resource is represented using a Resource indication value (RIV) method.

It should be noted that the above periodicity may be a periodicity in time domain or a periodicity in frequency domain.

Optionally, the parameter configuration information further includes at least one of the following:

a start position of the first signal in target domain;

a resource span of the first signal in target domain; and

a repetition periodicity of the first signal in time domain, where

the resource span of the first signal in target domain is a span of at least two resource blocks between a 1^{st} target resource unit and a last target resource unit in target domain.

The start position of the first signal in target domain includes the start position of the first signal in time domain and/or frequency domain, where the start position of the first signal in time domain includes a time domain position indicated by at least one of a frame number, a half-frame number, a subframe number, a slot number, and an OFDM symbol number, or includes a time offset relative to a preset reference signal, for example, a time offset relative to a Synchronization Signal Block (SSB) sent periodically. A parameter of the time offset herein includes at least one of a quantity of frames, a quantity of half-frames, a quantity of subframes, a quantity of slots, and a quantity of OFDM symbols. The start position of the first signal in frequency domain includes an offset relative to a preset reference point. The preset reference point includes one of the following: a point A or a PRB 0 of an active BWP, and the offset may be indicated by at least one of a quantity of Resource Block Groups (RBG), a quantity of RBs, and a quantity of REs.

The resource span of the first signal in target domain includes a resource span of the first signal in time domain and/or a resource span of the first signal in frequency domain. The resource span of the first signal in time domain is a time span between an OFDM symbol with a maximum index and an OFDM symbol with a minimum index allocated to the first signal in time domain. The resource span of the first signal in frequency domain is a time span between a subcarrier with a maximum index and a subcarrier with a minimum index allocated to the first signal in frequency domain.

It should be noted that the parameter configuration information is only a possible configuration parameter set. In specific implementation, another configuration parameter set may alternatively be used to implement a signal that meets the features 1 to 5, which also falls within the scope of protection of this application.

The resource span of the first signal in time domain, the span of the resource set in time domain, the target OFDM symbol interval, and a granularity of the position of the target OFDM symbol in time domain may be at least one of the following: preset duration (such as 1 ms), OFDM symbol duration, a slot, a subframe, a half-frame, and a frame.

The resource span of the first signal in frequency domain, the span of the resource set in frequency domain, the target subcarrier spacing, and a granularity of the position of the slot of the target subcarrier in frequency domain may be at least one of the following: a preset frequency width (such as 30 kHz), a subcarrier, an RB, and an RBG.

In an embodiment of this application, an example in which a configuration parameter of an existing NR reference signal (such as a CSI-RS) is used to implement the parameter configuration of the first signal is used for description, or an example in which a configuration parameter of an existing NR reference signal is slightly extended to implement the parameter configuration of the first signal is used for description. Specifically, the parameter configuration information of the first signal includes at least one of the following:

a first item: a time domain configuration parameter; and

a second item: a frequency domain configuration parameter.

The time domain configuration parameter includes at least one of the following:

B1: a start position of the first signal in time domain;

B2: a start position of each resource set of the first signal in time domain, where a start of a corresponding resource set in time domain is indicated by using a Radio Resource Control (RRC) configuration, a Medium Access Control Control Element (MAC CE), Downlink Control Information (DCI) signaling, or signaling of a combination of a MAC CE and DCI;

for example, in a case that a start position of a resource set in time domain is required to be a slot n, there are two methods: One is an RRC reconfiguration method, and the other is to activate (that is, activation) a new resource set by using a MAC CE or DCI;

B3: a repetition periodicity of a slot in which a target OFDM symbol in each resource set of the first signal is located, in a unit of a slot;

B4: a position of a target OFDM symbol in a slot in which the target OFDM symbol in each resource set of the first signal in the time slot, for example, indicated by lo or by lo and 11;

it is noted that positions of target OFDM symbols in slots in which the target OFDM symbols in different resource sets in time domain may be the same or different, and quantities of target OFDM symbols in slots in which the target OFDM symbols in the different resource sets in time domain may also be the same or different;

B5: an end position of each resource set of the first signal in time domain, where an end of a corresponding resource set is indicated by using RRC configuration, a MAC CE, DCI signaling, or signaling of a combination of a MAC CE and DCI;

for example, in a case that a resource set is required to end in a slot n, there are two methods: One is an RRC reconfiguration method, and the other is to deactivate (that is, deactivation) a corresponding resource set (Resource Set) by using a MAC CE or DCI; and

B6: a repetition periodicity of the first signal in time domain, that is, a time interval between two consecutive times of sending and receiving the first signal to perform a sensing process, and this parameter represents refresh time or refresh frequency of sensing.

The frequency domain configuration parameter includes at least one of the following:

C1: a start position of the first signal in frequency domain;

C2: a start position of each resource set of the first signal in frequency domain;

C3: a repetition periodicity of a target subcarrier in an RB in which the target subcarrier in each resource set of the first signal in frequency domain, in a unit of an RB or an RBG;

C4: a position of a target subcarrier in an RB in which the target subcarrier in each resource set of the first signal in frequency domain, for example, indicated by the bitmap;

C5: a position of a target subcarrier in an RB in which the target subcarrier in each resource set of the first signal in frequency domain, for example, indicated by the bitmap, where one bit (bit) of the bitmap represents one RB or one RBG; and

C6: a bandwidth occupied by each resource set of the first signal in frequency domain, that is, a bandwidth or a quantity of RBs corresponding to all subcarriers included between a target subcarriers with a minimum index and a target subcarriers with a maximum index in each resource set, or a bandwidth corresponding to all RBs or RBGs included between an RB or an RBG in which a target subcarriers with a minimum index is located and an RB or an RBG in which a target subcarriers with a maximum index is located in each resource set, which may be indicated by a preset bandwidth (such as 100 MHz) or a quantity of RBs/RBGs.

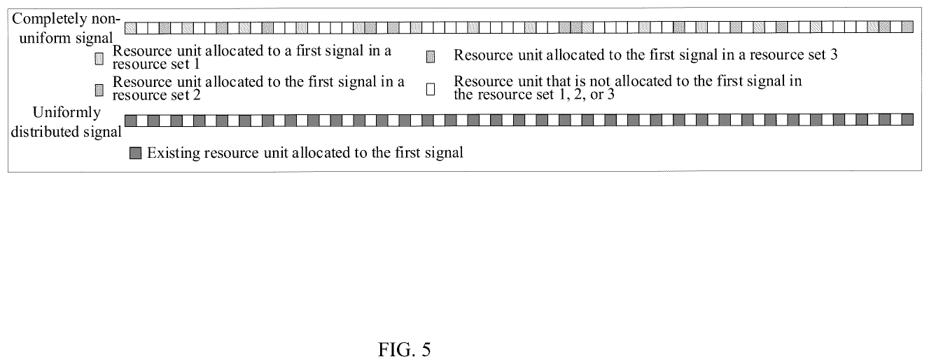

FIG. 5 is a schematic diagram of comparison between resource overheads of completely non-uniform signals used in this application and resource overheads of existing equivalent uniformly distributed signals in terms of a resolution and maximum unambiguous measurement range performance. Specifically, for the completely non-uniform signal in FIG. 5, refer to the completely non-uniform signal in FIG. 4. Benefits of this embodiment of this application are reflected in the following two aspects:

In a first aspect, on the premise of a same resolution and same maximum unambiguous measurement range performance, the completely non-uniform signal proposed in this application can occupy less time domain and/or frequency domain resources in many cases, that is, overheads can be reduced.

In a second aspect, this application can make full use of reference signals configured for a communication function and configure additional reference signals for a sensing function as little as possible. As shown in FIG. 4, a resource set 1, a resource set 2, and a resource set 3 may be different reference signals. For example, the resource set 1 is a CSI-RS, the resource set 2 is a Positioning Reference Signal (PRS), and the resource set 3 is a Phase-Tracking Reference Signal (PTRS) or a Demodulation Reference Signal (DMRS). In a case that the first signal formed by the resource set 1, the resource set 2, and the resource set 3 can meet the conditions of the feature 1 (T1 or F1) to the feature 3 (T3 or F3), sensing meeting the sensing requirement can be implemented without additional configuration of the reference signal. Alternatively, the resource set 1, the resource set 2, and the resource set 3 partially meet the feature 1 to the feature 3, and sensing meeting the sensing requirement can be implemented only by additionally configuring a small quantity of reference signals.

The method in this application is described below in detail with reference to a specific embodiment.

In an embodiment of this application, the first signal is configured in time domain using the completely non-uniform signal configuration method proposed in this application, and is configured in frequency domain according to another configuration method. For example, the first signal is configured in frequency domain through conventional uniform distribution.

In this case, the configuration parameter of the first signal in time domain in this application includes at least one of the following:

first indication information, used to indicate that the target domain is the time domain, for example, one bit is used for indication, and a bit 0 indicates the time domain;

a start position of the first signal in time domain;

a total span of the first signal in time domain;

a start position of one or more resource sets in time domain;

a span of one or more resource sets in time domain;

a position of a target OFDM symbol in one or more resource sets in time domain;

a target OFDM symbol interval in one or more resource sets;

a quantity of target OFDM symbols in one or more resource sets;

a density of target OFDM symbols in one or more resource sets;

a repetition periodicity of a slot, in time domain, in which a target OFDM symbol in one or more resource sets is located;

a position of a target OFDM symbol in a slot in which the target resource unit in the one or more resource sets is located; and

an indication for position distribution of target OFDM symbols in one or more resource sets (that is, second indication information).

In addition to the above configuration in time domain, the configuration of the first signal also needs to include the configuration in frequency domain. In this embodiment, the configuration in frequency domain uses a conventional uniform distribution configuration, including at least one of the following:

an indication that the target domain is the frequency domain, for example, one bit is used for indication, and the bit being “1” indicates the frequency domain;

a start position of the target resource in frequency domain;

a total span of the target resource in frequency domain;

a target subcarrier spacing of the target resource in frequency domain;

a quantity of target subcarriers included in the target resource in frequency domain; and

a target subcarrier density of the target resource in frequency domain.

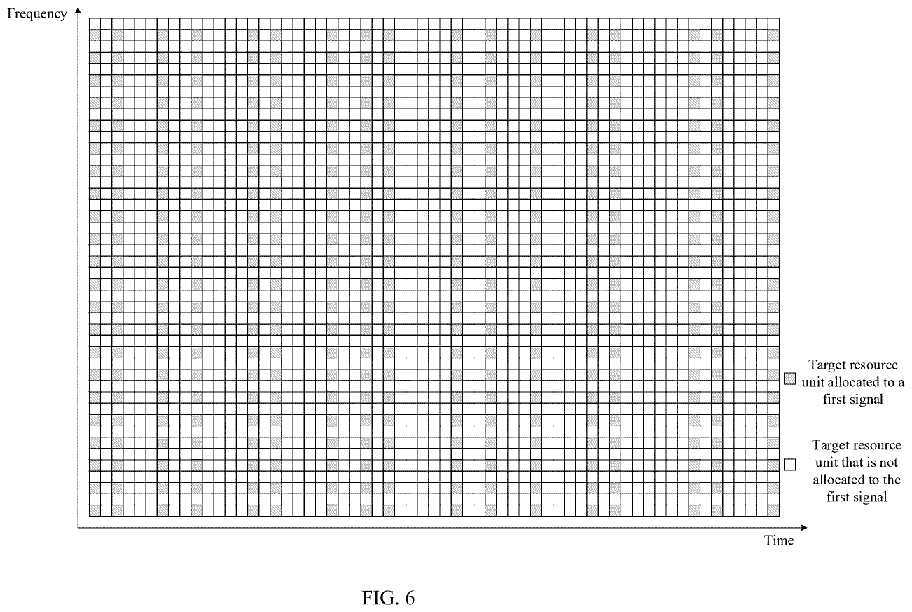

A schematic diagram of this embodiment is shown in FIG. 6, where in FIG. 6, a grid in a time dimension represents a target resource unit in time domain (such as an OFDM symbol) and a grid in frequency dimension represents a target resource unit in frequency domain (such as a subcarrier). It should be recognized that the schematic diagram is only used to facilitate the understanding of the technical solutions of the embodiments and does not mean that the signal configuration in the embodiments is limited to that shown in FIG. 6.

In FIG. 6, the completely non-uniform signal configuration described in this application is used in time domain. The target OFDM symbols are non-uniformly distributed in time domain, with their positions being {0, 2, 6, 9, 14, 16, 21, 24, 26, 32, 35, 39, 44, 46, 53, 55, 60}. Herein, the positions of the target OFDM symbols are relative to the start position of the target resource in time domain, with a granularity of an OFDM symbol. In addition, the conventional uniform distribution signal configuration is used in frequency domain, and a target resource unit interval in frequency domain is 2 subcarriers. In the example shown in FIG. 6, an average value of target OFDM symbol intervals in time domain is about 3.8 OFDM symbols, which is larger than the target OFDM symbol interval (2 OFDM symbols) required by the resolution of the Doppler or the speed, to reduce resource overheads of the first signal.

In an embodiment of this application, the first signal is configured in frequency domain using the completely non-uniform signal configuration method proposed in this application, and is configured in time domain according to another configuration method. For example, the first signal is configured in time domain through conventional uniform distribution.

In this case, the configuration of the first signal in frequency domain in this application includes at least one of the following:

first indication information, where the first indication information indicates that the target domain is the frequency domain, for example, one bit is used for indication, and a bit 1 indicates the frequency domain;

a start position of the first signal in frequency domain;

a resource span of the first signal in frequency domain;

a start position of one or more resource sets in frequency domain;

a span of one or more resource sets in frequency domain;

a position of a target subcarrier in one or more resource sets in frequency domain;

a target subcarrier spacing in one or more resource sets;

a quantity of target subcarriers in one or more resource sets;

a density of target subcarriers in one or more resource sets;

a repetition periodicity of an RB, in frequency domain, in which a target subcarrier in one or more resource sets is located;

a position of a target subcarrier in a slot in which the target resource unit in the one or more resource sets is located; and

an indication for position distribution of target subcarriers in one or more resource sets (that is, second indication information).

In addition to the above configuration in frequency domain, the configuration of the first signal also needs to include the configuration in time domain. In this embodiment, the configuration in time domain uses a conventional uniform distribution configuration, including at least one of the following:

an indication that the target domain is the time domain, for example, one bit is used for indication, and the bit being “0” indicates the time domain;

a start position of the target resource in time domain;

a resource span of the target resource in time domain;

a target OFDM symbol interval of the target resource in time domain;

a quantity of target OFDM symbols included in the target resource in time domain; and

a target OFDM symbol density of the target resource in time domain.

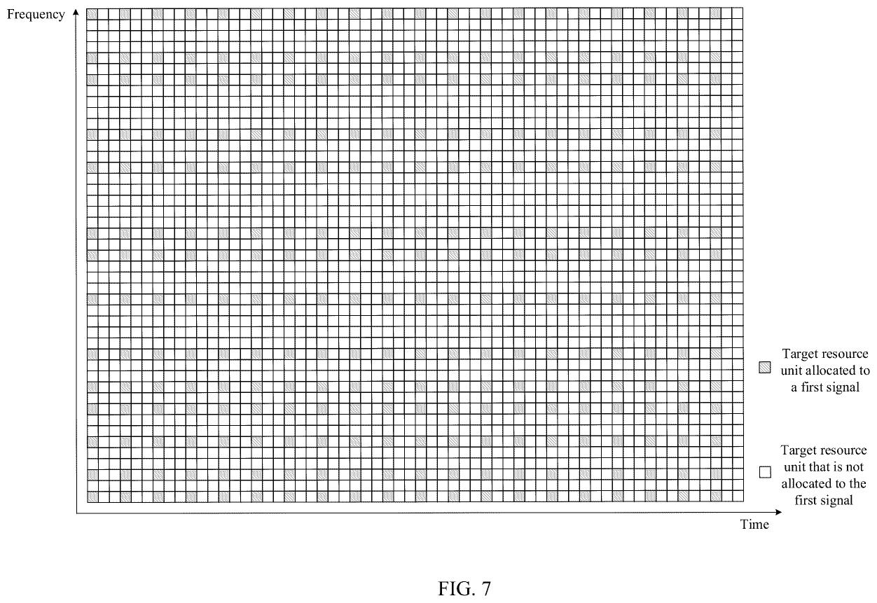

A schematic diagram of this embodiment is shown in FIG. 7, where in FIG. 7, a grid in a time dimension represents a target resource unit in time domain (such as an OFDM symbol) and a grid in frequency dimension represents a target resource unit in frequency domain (such as a subcarrier). It should be recognized that the schematic diagram is only used to facilitate the understanding of the technical solutions of the embodiments and does not mean that the signal configuration in the embodiments is limited to that shown in the figure.

In FIG. 7, the completely non-uniform signal configuration described in this application is used in frequency domain. The target subcarriers are non-uniformly distributed in frequency domain, with their positions being {0, 2, 5, 8, 10, 13, 18, 22, 24, 30, 33, 38, 40, 44}. Herein, the positions of the target subcarriers are relative to the start position of the target resource in frequency domain, with a granularity of a subcarrier. In addition, the conventional uniform distribution signal configuration is used in time domain, and a target OFDM symbol interval in time domain is 3 OFDM symbols. In the example shown in FIG. 7, an average value of target subcarrier spacings in frequency domain is about 3.2 subcarrier spacings, which is larger than the target subcarrier spacing (2 subcarriers) required by the resolution of the delay or the distance, to reduce resource overheads of the first signal.

In an embodiment of this application, the first signal is simultaneously configured in time domain and frequency domain using the completely non-uniform signal configuration method proposed in this application.

In this case, the parameter configuration information of the first signal in this application includes:

a time domain configuration parameter; and

a frequency domain configuration parameter.

The time domain configuration parameter includes at least one of the following:

first indication information, where the first indication information indicates that the target domain is the time domain, for example, one bit is used for indication, and a bit 0 indicates the time domain;

a start position of the first signal in time domain;

a resource span of the first signal in time domain;

a start position of one or more resource sets in time domain;

a span of one or more resource sets in time domain;

a position of a target OFDM symbol in one or more resource sets in time domain;

a target OFDM symbol interval in one or more resource sets;

a quantity of target OFDM symbols in one or more resource sets;

a density of target OFDM symbols in one or more resource sets;

a repetition periodicity of a slot, in time domain, in which a target OFDM symbol in one or more resource sets is located;

a position of a target OFDM symbol in a slot in which the target resource unit in the one or more resource sets is located; and

an indication for position distribution of target OFDM symbols in one or more resource sets (that is, second indication information).

The frequency domain configuration parameter includes at least one of the following:

first indication information, where the first indication information indicates that the target domain is the frequency domain, for example, one bit is used for indication, and a bit 1 indicates the frequency domain;

a start position of the first signal in frequency domain;

a resource span of the first signal in frequency domain;

a start position of one or more resource sets in frequency domain;

a span of one or more resource sets in frequency domain;

a position of a target subcarrier in one or more resource sets in frequency domain;

a target subcarrier spacing in one or more resource sets;

a quantity of target subcarriers in one or more resource sets;

a density of target subcarriers in one or more resource sets;

a repetition periodicity of an RB, in frequency domain, in which a target subcarrier in one or more resource sets is located;

a position of a target subcarrier in a slot in which the target resource unit in the one or more resource sets is located; and

an indication for position distribution of target subcarriers in one or more resource sets (that is, second indication information).

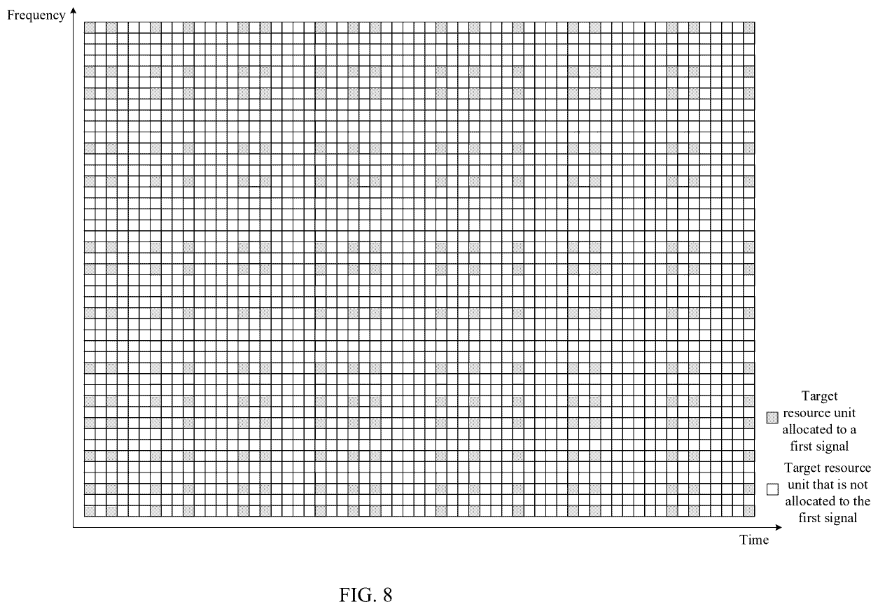

A schematic diagram of this embodiment is shown in FIG. 8, where in FIG. 8, a grid in a time dimension represents a target resource unit in time domain (such as an OFDM symbol) and a grid in frequency dimension represents a target resource unit in frequency domain (such as a subcarrier). It should be recognized that the schematic diagram is only used to facilitate the understanding of the technical solutions of the embodiments and does not mean that the signal configuration in the embodiments is limited to that shown in the figure.

In FIG. 8, the completely non-uniform signal configuration described in this application is used in time domain and frequency domain. The target OFDM symbols are non-uniformly distributed in time domain, with their positions being {0, 2, 6, 9, 14, 16, 21, 24, 26, 32, 35, 39, 44, 46, 53, 55, 60}. Herein, the positions of the target OFDM are relative to the start position of the target resource in time domain, with a granularity of an OFDM symbol. The target subcarriers are non-uniformly distributed in frequency domain, with their positions being {0, 2, 5, 8, 10, 13, 18, 22, 24, 30, 33, 38, 40, 44}. Herein, the positions of the target subcarriers are relative to the start position of the target resource in frequency domain, with a granularity of a subcarrier. In the example shown in FIG. 8, an average value of target OFDM symbol intervals in time domain is about 3.8 OFDM symbols, which is larger than the OFDM symbol interval (2 OFDM symbols) required by the resolution of the Doppler or the speed; and an average value of target subcarrier spacings in frequency domain is about 3.2 subcarrier spacings, which is larger than the target subcarrier spacing (2 subcarriers) required by the resolution of the delay or the distance, to reduce resource overheads of the first signal.

Optionally, the first signal is configured as single-port or multi-port;

in a case that the first signal is configured as multi-port, resources of first signals at different ports meet at least one of the following:

time division multiplexing; and

the first signals at the different ports have a same resource pattern in target domain,

and the first signals at the different ports use different generation sequences; or the first signals at the different ports have a same resource pattern in target domain, the first signals at the different ports use a same generation sequence, and different first signals correspond to different orthogonal cover codes.

In embodiments of this application, the first signal may be configured as multi-port, and a pattern relationship between the first signals at the different ports may include the following cases:

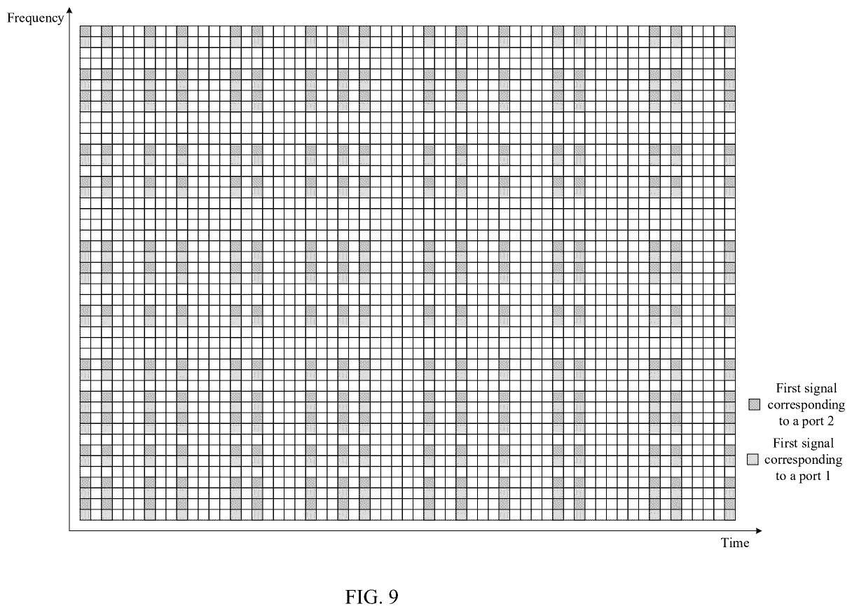

Case 1: Frequency division multiplexing is used for the first signals at the different ports, that is, the first signals at the different ports are distinguished by configuring different frequency domain offsets. For example, as shown in FIG. 9, 2 ports are frequency division multiplexed, a first signal frequency domain offset corresponding to a port 1 is 0 subcarriers, and a first signal frequency domain offset corresponding to a port 2 is 1 subcarrier. The port 1 and the port 2 have a same resource span and same resource distribution in frequency domain, that is, have same sensing performance.

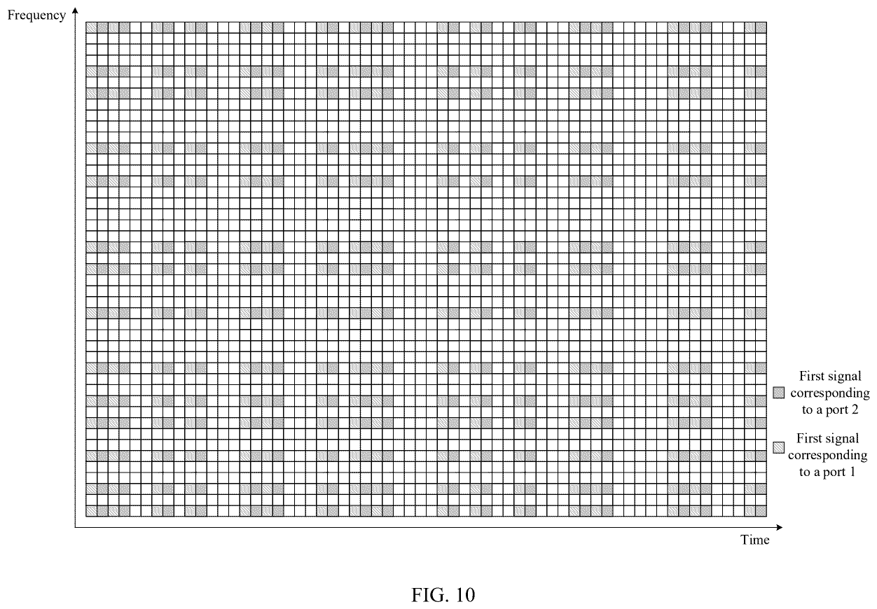

Case 2: Time division multiplexing is used for the first signals at the different ports, that is, the first signals at the different ports are distinguished by configuring different time domain offsets. For example, as shown in FIG. 10, 2 ports are time division multiplexed, a first signal time domain offset corresponding to a port 1 is 0 OFDM symbols, and a first signal time domain offset corresponding to a port 2 is 1 OFDM symbol. The port 1 and the port 2 have a same resource span and same resource distribution in time domain, that is, have same sensing performance.

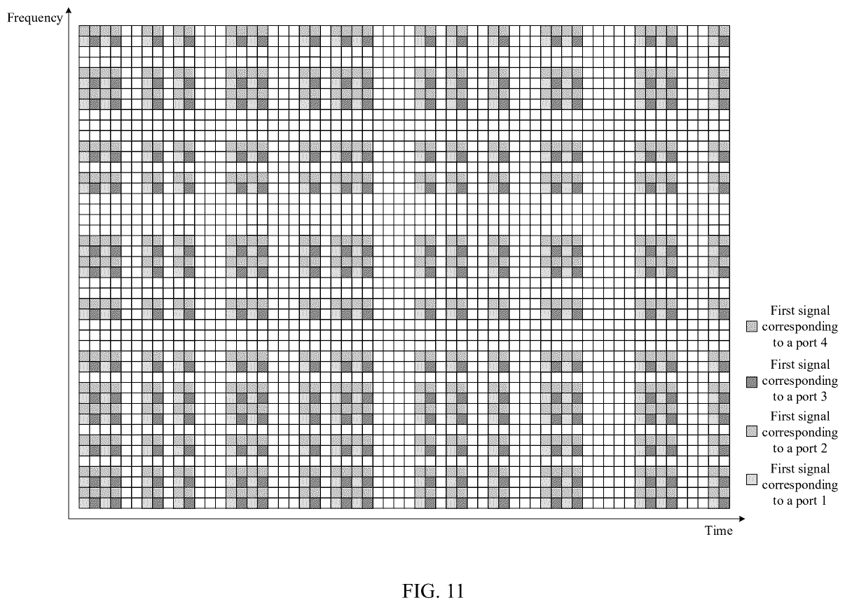

Case 3: Frequency division multiplexing and time division multiplexing are used for the first signals at the different ports, that is, the first signals at the different ports are distinguished by configuring different frequency domain offset and time domain offsets. For example, as shown in FIG. 11, 4 ports are frequency division multiplexed and time division multiplexed (FD2-TD2). A first signal frequency domain offset corresponding to a port 1 is 0 subcarriers and a first signal time domain offset is 0 OFDM symbols. A first signal frequency domain offset corresponding to a port 2 is 1 subcarrier and a first signal time domain offset is 0 OFDM symbols. A first signal frequency domain offset corresponding to a port 3 is 0 subcarriers and a first signal time domain offset is 1 OFDM symbol. A first signal frequency domain offset corresponding to a port 4 is 1 subcarrier and a first signal time domain offset is 1 OFDM symbol. The port 1, the port 2, the port 3, and the port 4 have a same resource span and same resource distribution in time domain and frequency domain, that is, have same sensing performance.

Case 4: The first signals at the different ports have a same pattern in target domain, that is, have a same time domain or frequency domain configuration parameter, but use different generation sequences for the first signal, that is, a generation parameter of the first signal sequence is related to a port sequence number.

Case 5: The first signals at the different ports have a same pattern in target domain, that is, have a same time domain or frequency domain configuration parameter, and use a same generation sequence for the first signal, but are distinguished by different Orthogonal Covering Code (OCC) when mapped to a time domain or frequency domain resource. For example, when first signals at 2 ports is mapped by using a Frequency domain orthogonal covering code (FD-OCC), a first signal sequence of the port 1 is c (m), and may be directly mapped to a frequency unit (such as an RE) corresponding to a specified time unit (such as an OFDM symbol). A first signal sequence of a port 2 may be c(m)*occ(m), and occ(m) is an FD-OCC sequence, which may be represented as (1,−1, 1,−1 . . . , 1,−1, 1,−1), and then mapped to the same frequency unit as the port 1.

An example in which the first Signal is an NR reference signal CSI-RS is used to describe the method in the embodiments of this application. Certainly, another reference signal such as a Demodulation Reference Signal (DMRS), a Phase-Tracking Reference Signal (PTRS), a Positioning Reference Signal (PRS), a Synchronization Signal Block (SSB), and another reference signal or synchronization signal are also covered by this application.

In a first embodiment of this application, the completely non-uniform signal described in this application is used in time domain. Distribution of the first signal in frequency domain is not limited herein. In some embodiments, the subcarriers allocated to the first signal are arranged in regular uniform distribution (comb distribution) in frequency domain. For example, a k^{th} subcarrier in each RB within a BWP in which the first signal is located is allocated to the first signal, where k is a subcarrier number in the RB.

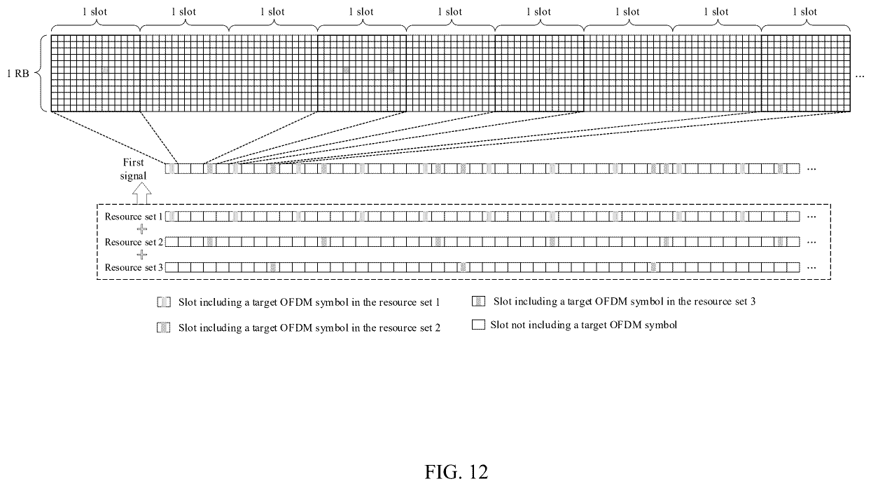

As shown in FIG. 12, the completely non-uniform signal described in this application is used in time domain. In the case shown in FIG. 12, the first signal includes three resource sets: A repetition periodicity of a resource set 1 in time domain is 5 slots, and an 8^{th} OFDM symbol (numbered from 0) in the slot is an OFDM symbol allocated to the first signal. A repetition periodicity of a resource set 2 in time domain is 9 slots, and 4^{th} and 11^{th} OFDM symbols (numbered from 0) in the slot are OFDM symbols allocated to the first signal. A repetition periodicity of a resource set 3 in time domain is 15 slots, and an 8^{th} OFDM symbol (numbered from 0) in the slot is an OFDM symbol allocated to the first signal.

A typical scenario of this configuration is, for example, for a communication function, a CSI-RS appears on one OFDM symbol in one slot, and a repetition periodicity of the CSI-RS is configured as 5 slots (that is, the case shown in the resource set 1), so that a requirement can be met. For a sensing scenario (Doppler or speed measurement herein), a maximum unambiguous measurement range of the Doppler or the speed requires that an OFDM symbol interval of the CSI-RS is not large than duration of 1 slot. In a case that a CSI-RS configuration that meets the sensing requirement is used on all slots, high additional overheads are caused. According to the method described in this application, only an additional part of the CSI-RS configuration needs to be supplemented beyond the CSI-RS configuration overheads required for the communication function, and additional overheads are low on the premise that the sensing requirement is met.

It is easy to understand that the configuration shown in this embodiment is only an example. The CSI-RS in the existing protocol cannot support the periodicity of 9 slots and the periodicity of 15 slots shown in FIG. 12, and the parameters given in this embodiment are only for convenience.

In this embodiment, the parameter configuration information used to describe the first signal meeting the above feature includes the following content:

(1) The start position of the first signal in time domain is an index of a 1^{st} slot occupied by the first signal in time domain, and is represented as Nₛₗₒₜ^{frame,μ}n_{f}+n_{s,f}, where n_{f}, is a system frame number, Nₛₗₒₜ^{frame,μ} slot is a quantity of slots included in a system frame, and n_{s,f}^{μ} is a slot number in the system frame.

(2) The start position of each resource set of the first signal in time domain is an index of a 1^{st} slot of each resource set of the first signal in time domain, is represented as a slot offset relative to the start position of the first signal in time domain, is represented as T_{offset} in a unit of a slot, and may be configured by using CSI-ResourcePeriodicity AndOffset or CSI-RS-Resource-Mobility->slotConfig.

Alternatively, the configuration parameter of the first signal does not include a start position of at least a part of the resource sets, and instead indicate a start of a corresponding resource set in time domain by using an RRC configuration, or a MAC CE, DCI signaling, or signaling of a combination of a MAC CE and DCI.

(3) The repetition periodicity of each resource set of the first signal in time domain is a repetition periodicity of a slot including the target OFDM symbol in each resource set of the first signal in time domain, is represented as T_{CSI-RS} in a unit of a slot, and may be configured by using CSI-ResourcePeriodicity AndOffset or CSI-RS-Resource-Mobility->slotConfig. (4) An index of the target OFDM symbol in the slot including the target OFDM symbol in each resource set of the first signal, for example, represented as l₀ in a unit of an OFDM symbol (when there is only one target OFDM symbol), or represented as l₀ and l₁ (when there are two target OFDM symbols, this is the case in this embodiment), may be configured by using firstOFDMSymbolInTimeDomain and/or firstOFDMSymbolInTimeDomain2 in CSI-ResourceMapping.

(5) an end position of each resource set of the first signal in time domain, where an end of a corresponding resource set is indicated by using RRC configuration, a MAC CE, DCI signaling, or signaling of a combination of a MAC CE and DCI.

(6) a beam Identifier (ID): All resource sets belonging to a same first signal should be associated to a same beam, that is, there is a Quasi Co-Location (QCL) relationship between all resource sets, which may be configured by using tci-StatesToAddModList. QCL may be configured between resource sets, or QCL between resource sets and the same other signal (such as an SSB).

(7) a resource set list: A list of IDs of all resource sets belonging to the same first signal is used to inform a receiver of the first signal which resource sets belong to the corresponding first signal.

In a second embodiment of this application, the completely non-uniform signal described in this application is used in frequency domain. The distribution of the first signal in time domain is not limited herein. In some embodiments, the OFDM symbols allocated to the first signal are arranged in time domain in regular uniform distribution (that is, comb distribution). For example, an 1^{th} OFDM symbol of a 1^{st} slot in every 4 slots is allocated to the first signal, where 1 is a number of the OFDM symbol in the slot.

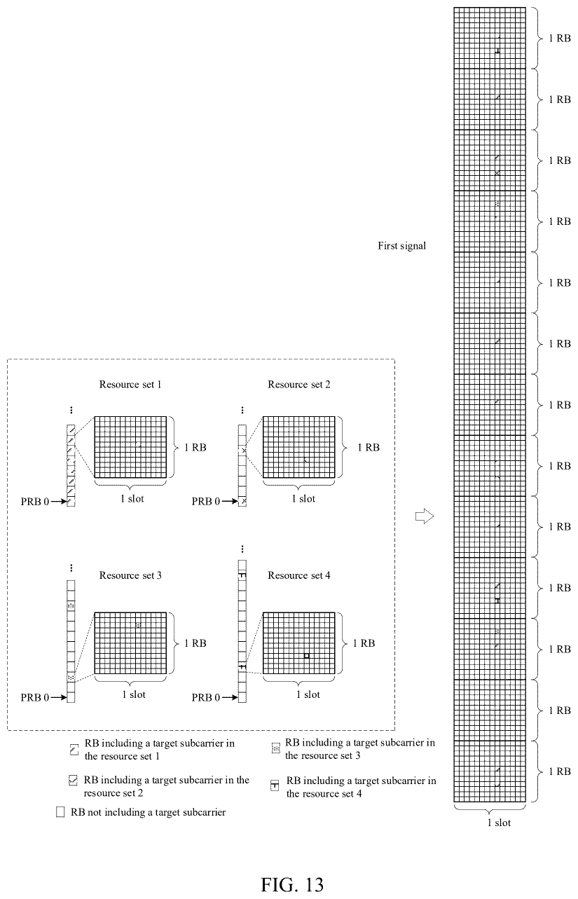

In the case shown in FIG. 13, the first signal includes four resource sets: A repetition periodicity of a resource set 1 in frequency domain is 1 RB, and a 6^{th} subcarrier (numbered from 0) in each RB is allocated to the first signal. A repetition periodicity of a resource set 2 in frequency domain is 5 RBs, and a 3^{rd} subcarrier (numbered from 0) in each RB is allocated to the first signal. A repetition periodicity of a resource set 3 in frequency domain is 7 RBs, and a 9^{th} subcarrier (numbered from 0) in each RB is allocated to the first signal. A repetition periodicity of a resource set 4 in frequency domain is 9 RBs, and a 3^{rd} subcarrier (numbered from 0) in each RB is allocated to the first signal.

A typical scenario of this configuration is that for a sensing scenario (delay or distance measurement herein), the target subcarriers need to be distributed denser in frequency domain, for example, in a case that the conventional uniform distribution (comb distribution) is used, 3 subcarriers in each RB are allocated to the first signal. However, it is possible that the CSI-RS can meet the requirement for the communication function when there is 1 subcarrier in each RB, which is the case of the resource set 1 in FIG. 13. According to the configuration method of this application, a small quantity of subcarrier configurations can be added to the first signal to meet the requirement for the sensing function without adding excessive additional resource overheads.

It is easy to understand that the configuration shown in this embodiment is only an example. The existing protocol cannot support the frequency domain periodicity of the CSI-RS to be 5RBs, 7 RBs, and 9 RBs, and the parameters given in this embodiment are only for convenience.

For the parameter configuration information of the first signal in this embodiment, considering the following configuration methods, the parameter configuration information used to describe the first signal meeting the above features includes at least one of the following content:

(1) The start position of the first signal in frequency domain is an RB with a minimum index occupied by the first signal in frequency domain, which may be configured by using CSI-frequencyOccupation->startingRB, where startingRB is a start RB.

(2) The start position of each resource set of the first signal in frequency domain is an RB with a minimum index of each resource set of the first signal in frequency domain, which may be configured by using CSI-frequencyOccupation->startingRB.

(3) The density of target subcarriers in frequency domain in each resource set of the first signal is a quantity of target subcarriers in 1 RB, and may be configured by using CSI-RS-ResourceMapping->density.

(4) The position of the target subcarrier in the RB in which the target subcarrier in each resource set of the first signal may be configured by using CSI-RS-ResourceMapping->frequencyDomainAllocation.

(5) The bandwidth occupied by each resource set of the first signal in frequency domain is configured by using CSI-frequencyOccupation->nrofRBs, where nrofRBs is a quantity of RBs.

(6) The beam ID: All resource sets belonging to a same first signal should be associated to a same beam, that is, there is a QCL relationship between all resource sets, which may be configured by using tci-StatesToAddModList. QCL may be configured between resource sets, or QCL between resource sets and the same other signal (such as an SSB).

(7) The resource set list: A list of IDs of all resource sets belonging to the same first signal is used to inform a receiver of the first signal which resource sets belong to the corresponding first signal.

In a third embodiment of this application, the completely non-uniform signal of this application is used in time domain and frequency domain, and in a case that the first signal includes M resource sets in time domain and N resource sets in frequency domain, the first signal includes a total of M*N resource sets. A configuration parameter of each resource set in time domain are the same as the second embodiment, and a configuration parameter of each resource set in frequency domain are the same as the first embodiment.

The above scheme in this embodiment of this application can easily combine the existing reference signals to implement the resource configuration of the first signal, and significantly reduce the time domain resource overheads of the first signal.

Optionally, the method in this embodiment of this application further includes:

The first device sends capability information, where the capability information is used to indicate whether the first device has a capability to process the first signal meeting the first feature.

Optionally, the capability information is used to indicate whether the first device has a capability to perform a spectral analysis operation on a non-uniform signal sequence.

In this embodiment of this application, use of the completely non-uniform signal requires a receiver of the first signal to be able to perform the spectral analysis operation on the non-uniform signal sequence. Therefore, the capability information herein further needs to include both conventional sensing capability information and a spectral analysis operation capability on the non-uniform signal sequence. Typical spectral analysis algorithms for the non-uniform signal sequence include Non-Uniform Fast Fourier Transform (NUFFT), Multiple Signal Classification (MUSIC), and the like.

In a case that the first equipment does not have the capability to perform spectral analysis on the non-uniform signal sequence, the completely non-uniform signal described in this application cannot be used. Alternatively, the first device sends obtained data corresponding to the first signal to a sensing function network element (for example, a base station or a core network device), and the sensing function network element performs the spectral analysis operation on the non-uniform signal sequence. In this case, the first device is not required to have the capability of the spectral analysis operation on the non-uniform signal sequence.

Optionally, the method in this embodiment of this application further includes: performing a first operation on the first signal according to the parameter configuration information of the first signal, where the first operation includes at least one of sending, receiving, and signal processing.

Optionally, the method in this embodiment of this application further includes:

The first device obtains an activation instruction for the one or more resource sets, where the activation instruction is used to instruct the first device to perform a first operation on the first signal corresponding to the one or more resource sets, and the first operation includes at least one of sending, receiving, and signal processing.

Optionally, the activation signaling is obtained by using RRC signaling, a MAC CE, or DCI.

Optionally, the method further includes:

The first device obtains a deactivation instruction for the one or more resource sets, where the deactivation instruction is used to instruct the first device to stop performing the first operation on the first signal corresponding to the at least one or more resource sets, and the first operation includes at least one of sending, receiving, and signal processing.

Optionally, the deactivation signaling is obtained by using RRC signaling, a MAC CE, or DCI.

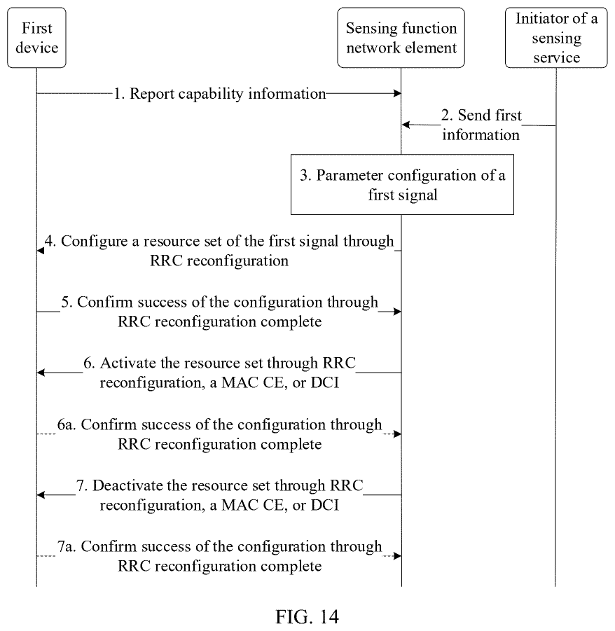

In an embodiment of this application, the CSI-RS is used as an example (also applicable to using another NR reference signal (such as the DMRS and the Sounding Reference Signal (SRS))), as shown in FIG. 14, which may specifically include the following steps:

Step 1: A first device (for example, User Equipment (UE)) reports capability information.

The capability information includes at least one of the following:

sensing capability information of the UE; and

whether the UE has a capability to perform a spectral analysis operation on a non-uniform signal sequence.

Step 2: A sensing function network element (for example, a base station or a core network device, where the sensing function network element is the foregoing second device) obtains first information from an initiator of a sensing service. The first information includes at least one of the following:

A1: sensing prior information, including at least one of the following:

spatial range information of a sensing target area;

prior information of an empty position of a sensing object; and

prior information of a motion parameter of the sensing object, such as a motion speed range and an acceleration range of the sensing object; and

A2: sensing requirement information, including at least one of the following:

(1) a sensing service type: divided by type or specific to a service, such as imaging, positioning or trajectory tracking, motion recognition, ranging/speed measurement;

(2) a sensing target area: is a location area in which a sensing object may be present, or a location area that requires imaging or environmental reconstruction;

(3) a sensing object type: a sensing object is classified according to a possible motion characteristic of the sensing object, and each sensing object type includes information such as a motion speed, motion acceleration, and a typical Rich Communication Suite (RCS) of a typical sensing object;

(4) sensing Quality of Service (QOS): a performance indicator for sensing the sensing target area or the sensing object includes at least one of the following:

a sensing resolution (which may be further divided into: a distance/delay resolution, an angle resolution, a speed/Doppler resolution, and an imaging resolution);

sensing accuracy (which may be further divided into: distance/delay accuracy, angle accuracy, speed/Doppler accuracy, positioning accuracy, and the like);

a sensing range (which may be further divided into: a distance/delay range, a speed/Doppler range, an angle range, an imaging range, and the like);

a sensing delay (which is a time interval from sending of a sensing signal to obtaining of a sensing result, or a time interval from initiating of a sensing requirement to obtaining of a sensing result);

a sensing update rate (which is a time interval at which two consecutive times of executing sensing and obtaining a sensing result);

a detection probability (which is a probability of correctly detecting a sensing object in a case that the sensing object is present);

a false alarm probability (which is a probability of incorrectly detecting a sensing target in a case that the sensing object is absent); and

a maximum quantity of targets that can be sensed.

Step 3: The sensing function network element (that is, the second device, such as the base station or the core network device) performs a parameter configuration of a first signal according to the first information in combination with the capability information of the first device, and the like, to obtain a configuration parameter of a resource set of the first signal that meets time domain features T1 to T5 and/or frequency domain features F1 to F5.

It should be noted that the resource set of the first signal described herein includes a resource set included in the first signal when a sensing task is performed and a resource set included in the first signal after switching, where the latter may not be present.

Step 4: The sensing function network element (such as the base station or the core network device) sends the configuration parameter of the resource set of the first signal to the first device (such as the UE) through RRC reconfiguration (RRCReconfiguration).

Step 4 may be implemented in the following manner:

sending the configuration parameter of the resource set of the first signal to the first device; and

notifying the first device of a type or an identifier of the configuration parameter of the resource set of the first signal, where configuration parameters, of the resource set of the first signal, of different types or identifiers may be agreed on in the protocol or notified to the first device in advance (for example, the configuration parameters, of the first signal, of different types or identifiers in target domain are indicated by using RRC signaling, or a configuration type or identifier of the first signal is indicated by using layer 1 signaling, or layer 2 signaling, or signaling of a combination of layer 1 and layer 2).

Step 5: The first device returns information to the sensing function network element through RRC reconfiguration complete (RRCReonfigurationComplete), to confirm correct reception of the configuration parameter of the resource set of the first signal.

Step 6: The sensing function network element sends an activation instruction for all or a part of the resource sets of the first signal to the first device by using RRC signaling, a MAC CE, or DCI. The first device performs a first operation on the first signal.

The activation instruction is used to indicate at least one of the following:

Starts of periodic (periodic), semi-persistent (semi-persistent), an aperiodic (aperiodic) resource sets are indicated through RRCReconfiguration configuration. In this case, the first device needs to return RRCReonfigurationComplete to the sensing function network element (step 6a in the figure).

A start of a semi-persistent resource set and/or one time of execution of an aperiodic resource set are/is indicated by using a MAC CE and/or DCI.

This process may be performed for a plurality of times, for example, a plurality of pieces of signaling are used to respectively perform activation of a plurality of resource sets at different time domain start positions.

Step 7: The sensing function network element sends a deactivation instruction for all or a part of the resource sets of the first signal to the first device by using RRC signaling, a MAC CE, or DCI. The first device stops performing the first operation on the signal on all or the part of the resource sets.

The deactivation instruction is used to indicate at least one of the following:

An end of the periodic resource set is indicated through RRCReconfiguration configuration. In this case, the first device needs to return RRCReonfigurationComplete to the sensing function network element (step 7a in the figure).

An end of a semi-persistent resource set is indicated by using a MAC CE and/or DCI.

This process may be performed for a plurality of times, for example, a plurality of pieces of signaling are used to respectively perform deactivation of a plurality of resource sets at different time domain end positions.

According to the method in this embodiment of this application, the resource overheads of the sensing signal can be greatly reduced on the premise of meeting the sensing resolution performance and the performance of the maximum unambiguous measurement range. In addition, the method in this embodiment of this application can conveniently combine the existing reference signal to implement the configuration of the sensing signal, and further reduce the resource overheads.

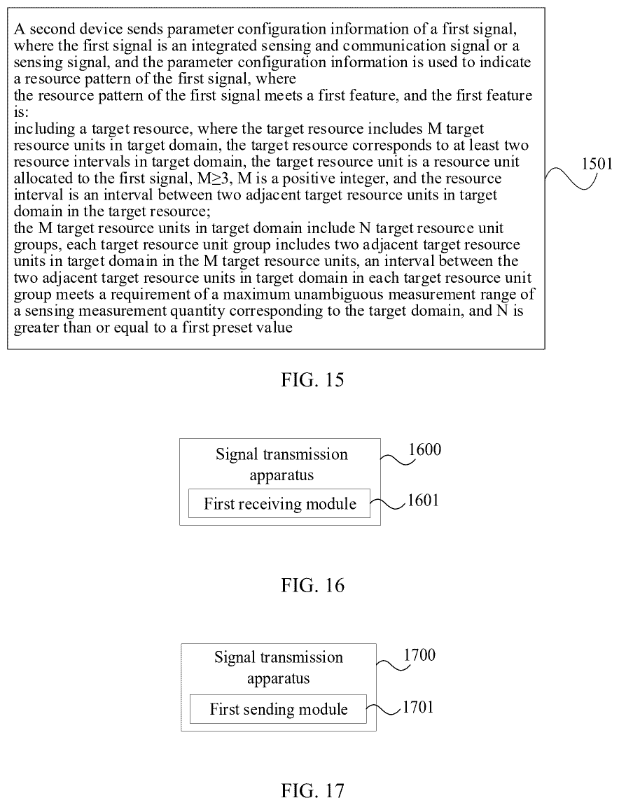

As shown in FIG. 15, an embodiment of this application further provides a signal transmission method, including the following steps.

Step 1501: A second device sends parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

In this embodiment of this application, the second device sends the parameter configuration information of the first signal to the first device, the first device includes but is not limited to a terminal or a base station, and the second device includes but is not limited to a base station or a core network device.

Optionally, the method in this embodiment of this application further includes:

The second device obtains capability information sent by a first device, where the capability information is used to indicate whether the first device has a capability to process the first signal meeting the first feature.

Optionally, the parameter configuration information includes resource configuration information of one or more resource sets, each resource set includes at least one target resource unit, and the one or more resource sets constitute the M target resource units.

Optionally, the method in this embodiment of this application further includes:

The second device performs a first operation on the first signal according to the parameter configuration information of the first signal, where the first operation includes at least one of sending, receiving, and signal processing.

Optionally, the method in this embodiment of this application further includes:

The second device sends an activation instruction for the one or more resource sets, where the activation instruction is used to instruct the first device to perform a first operation on the first signal corresponding to the one or more resource sets, and the first operation includes at least one of sending, receiving, and signal processing.

Optionally, the method in this embodiment of this application further includes:

The second device sends a deactivation instruction for the one or more resource sets, where the deactivation instruction is used to instruct the first device to stop performing the first operation on the first signal corresponding to the at least one or more resource sets, and the first operation includes at least one of sending, receiving, and signal processing.

In this embodiment of this application, the second device sends the parameter configuration information of the first signal, where the first signal is the integrated sensing and communication signal or the sensing signal, the resource pattern of the first signal meets the first feature, and the first feature is: including the target resource, where the target resource includes the M target resource units in target domain, the target resource corresponds to the at least two resource intervals in target domain, and the target resource unit is the resource unit allocated to the first signal; and the M target resource units in target domain include the N target resource unit groups, each target resource unit group includes the two adjacent target resource units in target domain in the M target resource units, and the interval between the two adjacent target resource units in target domain in each target resource unit group meets the requirement for the maximum unambiguous measurement range of the sensing measurement quantity corresponding to the target domain. The M target resource units correspond to the at least two resource intervals in target domain, and in the integrated sensing and communication scenario, according to the sensing requirement, a resource interval between some adjacent target resource units in target domain can be set as a resource interval meeting a resolution requirement for a corresponding sensing measurement quantity, while a resource interval between remaining adjacent target resource units in target domain is greater than the resource interval of the resolution requirement for the corresponding sensing measurement quantity. Therefore, resource overheads are reduced on the premise that the first signal can meet the sensing requirement.

The signal transmission method provided in the embodiments of this application may be performed by a signal transmission apparatus. The signal transmission apparatus provided in the embodiments of this application is described by using an example in which the signal transmission apparatus performs the signal transmission method in the embodiments of this application.

As shown in FIG. 16, an embodiment of this application further provides a signal transmission apparatus 1600, applied to a first device, and including:

a first receiving module 1601, configured to receive parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

Optionally, the target domain includes the time domain, and an interval between two adjacent target resource units in time domain in each resource unit group meets a requirement for a maximum unambiguous measurement range of the Doppler or the speed.

Optionally, the target domain includes the frequency domain, and an interval between two adjacent target resource units in frequency domain in each resource unit group meets a requirement for a maximum unambiguous measurement range of the delay or the distance.

Optionally, a resource span of the M target resource units in target domain meets a resolution requirement for the sensing measurement quantity corresponding to the target domain.

Optionally, the target domain includes the time domain, and a resource span of the M target resource units in time domain meets a resolution requirement for the Doppler or the speed.

Optionally, the target domain includes the frequency domain, and a resource span of the M target resource units in frequency domain meets a resolution requirement for the delay or the distance.

Optionally, the target domain includes the time domain, and a ratio of a first parameter of a first side lobe to a first parameter of a main lobe of a time domain signal sequence of the first signal in first transform domain is less than a first preset threshold; and/or

the target domain includes the frequency domain, and a ratio of a second parameter of a second side lobe to a second parameter of a main lobe of a frequency domain signal sequence of the first signal in second transform domain is less than a second preset threshold, where

the first transform domain is a Doppler domain, the first side lobe is a side lobe with a maximum amplitude or power in Doppler domain, and the first parameter includes an amplitude or a power; and

the second transform domain is a delay domain, the second side lobe is a side lobe with a maximum amplitude or power in delay domain, and the second parameter includes an amplitude or a power.

Optionally, the parameter configuration information includes resource configuration information of one or more resource sets, each resource set includes at least one target resource unit, and the target resource includes the one or more resource sets.

Optionally, the resource configuration information of the one or more resource sets includes at least one of the following:

a start position of the one or more resource sets in target domain;

a span of the one or more resource sets in target domain;

a resource interval between target resource units in the one or more resource sets;

a quantity of target resource units in the one or more resource sets;

a density of target resource units in the one or more resource sets;

a repetition periodicity of a slot, in time domain, in which a target resource unit in the one or more resource sets is located;

a position of a target resource unit in a slot in which the target resource unit in the one or more resource sets is located;

a repetition periodicity of a resource block RB, in frequency domain, in which a target resource unit in the one or more resource sets is located;

a position of an RB, in frequency domain, in which a target resource unit in the one or more resource sets is located;

a position, in an RB, of a target resource unit in the one or more resource sets;

first indication information, where the first indication information is used to indicate that the target domain is the time domain and/or the frequency domain; and

second indication information, where the second indication information is used to indicate position distribution of target resource units in the one or more resource sets in target domain, where

the span of the resource set in target domain is a span between a 1^{st} resource unit and a last resource unit of the resource set in target domain.

Optionally, the parameter configuration information further includes at least one of the following:

a start position of the first signal in target domain;

a resource span of the first signal in target domain; and

a repetition periodicity of the first signal in time domain, where

the resource span of the first signal in target domain is a span of at least two resource blocks between a 1^{st} target resource unit and a last target resource unit in target domain.

Optionally, the second indication information includes at least one of the following:

a bitmap, where the bitmap includes L bits, and each bit corresponds to one resource unit; in a case that a value corresponding to the bit is a first value, the resource unit corresponding to the bit is a target resource unit allocated to the resource set, or in a case that a value corresponding to the bit is a second value, the resource unit corresponding to the bit is not a target resource unit allocated to the resource set; and L is a positive integer;

parameter information of a sub-block, where the parameter information of the sub-block includes at least one of position distribution information of a target resource unit in the sub-block, a quantity X of sub-blocks, a repetition periodicity of the sub-block, and a start position of a 1^{st} sub-block in X sub-blocks, and X is a positive integer; and

parameter information of a target formula, where the target formula is a formula used to calculate position information of the target resource unit in the resource set in target domain, the parameter information of the target formula includes at least one of a type of the target formula, a formula parameter of the target formula, and a calculation result that is obtained according to the target formula, and the calculation result is used to indicate the position information.

Optionally, the first signal is configured as single-port or multi-port;

in a case that the first signal is configured as multi-port, resources of first signals at different ports meet at least one of the following:

time division multiplexing; and

the first signals at the different ports have a same resource pattern in target domain,

and the first signals at the different ports use different generation sequences; or the first signals at the different ports have a same resource pattern in target domain, the first signals at the different ports use a same generation sequence, and different first signals correspond to different orthogonal cover codes.

Optionally, the apparatus in this embodiment of this application further includes:

a second sending module, configured to send capability information, where the capability information is used to indicate whether the first device has a capability to process the first signal meeting the first feature.

Optionally, the apparatus in this embodiment of this application further includes:

a first execution module, configured to perform a first operation on the first signal according to the parameter configuration information of the first signal, where the first operation includes at least one of sending, receiving, and signal processing.

Optionally, the apparatus in this embodiment of this application further includes:

a second obtaining module, configured to obtain an activation instruction for the one or more resource sets, where the activation instruction is used to instruct the first device to perform a first operation on the first signal corresponding to the one or more resource sets, and the first operation includes at least one of sending, receiving, and signal processing.

Optionally, the apparatus in this embodiment of this application further includes:

a third obtaining module, configured to obtain a deactivation instruction for the one or more resource sets, where the deactivation instruction is used to instruct the first device to stop performing the first operation on the first signal corresponding to the at least one or more resource sets, and the first operation includes at least one of sending, receiving, and signal processing.

According to the apparatus in this embodiment of this application, the first device receives the parameter configuration information of the first signal, where the first signal is the integrated sensing and communication signal or the sensing signal, the resource pattern of the first signal meets the first feature, and the first feature is: including the target resource, where the target resource includes the M target resource units in target domain, the target resource corresponds to the at least two resource intervals in target domain, and the target resource unit is the resource unit allocated to the first signal; and the M target resource units in target domain include the N target resource unit groups, each target resource unit group includes the two adjacent target resource units in target domain in the M target resource units, and the interval between the two adjacent target resource units in target domain in each target resource unit group meets the requirement for the maximum unambiguous measurement range of the sensing measurement quantity corresponding to the target domain. The M target resource units correspond to the at least two resource intervals in target domain, and in the integrated sensing and communication scenario, according to the sensing requirement, a resource interval between some adjacent target resource units in target domain can be set as a resource interval meeting a resolution requirement for a corresponding sensing measurement quantity, while a resource interval between remaining adjacent target resource units in target domain is greater than the resource interval of the resolution requirement for the corresponding sensing measurement quantity. Therefore, resource overheads are reduced on the premise that the first signal can meet the sensing requirement.

As shown in FIG. 17, an embodiment of this application further provides a signal transmission apparatus 1700, applied to a second device, and including:

a first sending module 1701, configured to send parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

Optionally, the apparatus in this embodiment of this application further includes:

a first obtaining module, configured to obtain capability information sent by a first device, where the capability information is used to indicate whether the first device has a capability to process the first signal meeting the first feature.

Optionally, the parameter configuration information includes resource configuration information of one or more resource sets, each resource set includes at least one target resource unit, and the one or more resource sets constitute the M target resource units.

Optionally, the apparatus in this embodiment of this application further includes:

a second execution module, configured to perform a first operation on the first signal according to the parameter configuration information of the first signal, where the first operation includes at least one of sending, receiving, and signal processing.

Optionally, the apparatus in this embodiment of this application further includes:

a third sending module, configured to send an activation instruction for the one or more resource sets, where the activation instruction is used to instruct the first device to perform a first operation on the first signal corresponding to the one or more resource sets, and the first operation includes at least one of sending, receiving, and signal processing.

Optionally, the apparatus in this embodiment of this application further includes:

a fourth sending module, configured to send a deactivation instruction for the one or more resource sets, where the deactivation instruction is used to instruct the first device to stop performing the first operation on the first signal corresponding to the at least one or more resource sets, and the first operation includes at least one of sending, receiving, and signal processing.

According to the apparatus in this embodiment of this application, the second device sends the parameter configuration information of the first signal, where the first signal is the integrated sensing and communication signal or the sensing signal, the resource pattern of the first signal meets the first feature, and the first feature is: including the target resource, where the target resource includes the M target resource units in target domain, the target resource corresponds to the at least two resource intervals in target domain, and the target resource unit is the resource unit allocated to the first signal; and the M target resource units in target domain include the N target resource unit groups, each target resource unit group includes the two adjacent target resource units in target domain in the M target resource units, and the interval between the two adjacent target resource units in target domain in each target resource unit group meets the requirement for the maximum unambiguous measurement range of the sensing measurement quantity corresponding to the target domain. The M target resource units correspond to the at least two resource intervals in target domain, and in the integrated sensing and communication scenario, according to the sensing requirement, a resource interval between some adjacent target resource units in target domain can be set as a resource interval meeting a resolution requirement for a corresponding sensing measurement quantity, while a resource interval between remaining adjacent target resource units in target domain is greater than the resource interval of the resolution requirement for the corresponding sensing measurement quantity. Therefore, resource overheads are reduced on the premise that the first signal can meet the sensing requirement.

The signal transmission apparatus 1700 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The signal transmission apparatus 1700 provided in this embodiment of this application can implement the processes implemented in the method embodiments in FIG. 2 to FIG. 15, and a same technical effect can be achieved. To avoid repetition, details are not described herein again.

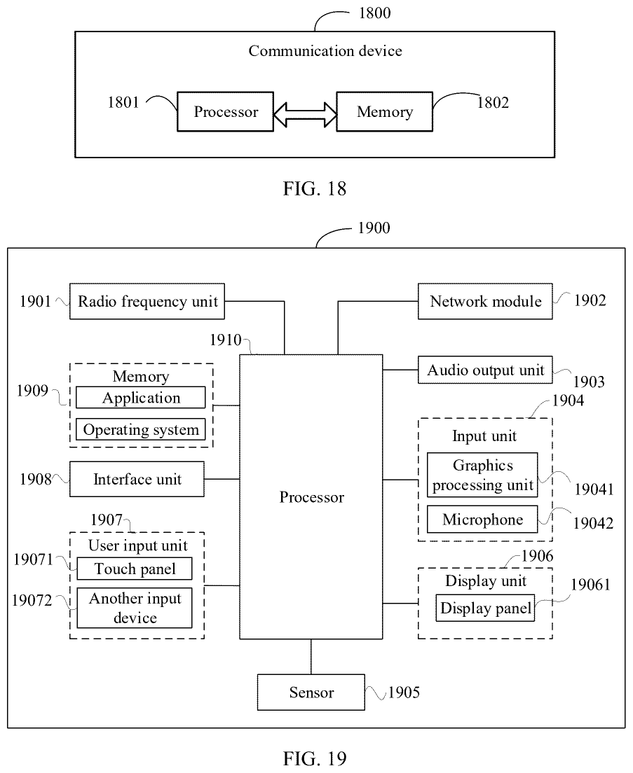

Optionally, as shown in FIG. 18, an embodiment of this application further provides a communication device 1800, including a processor 1801 and a memory 1802, and the memory 1802 stores a program or an instruction that is executable on the processor 1801. For example, in a case that the communication device 1800 is a terminal, when the program or the instruction is executed by the processor 1801, the steps of the foregoing embodiment of the signal transmission method performed by the first device are implemented, and a same technical effect can be achieved. In a case that the communication device 1800 is a network side device, the program or the instruction is executed by the processor 1801 to implement the steps of the foregoing embodiment of the signal transmission method performed by the first device or the second device, and a same technical effect can be achieved. To avoid repetition, details are not described herein again.

An embodiment of this application further provides a terminal, including a processor and a communication interface. The communication interface is configured to receive parameter configuration information of a first signal, where the first signal is an integrated sensing and communication signal or a sensing signal, and the parameter configuration information is used to indicate a resource pattern of the first signal, where the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain. The terminal embodiment corresponds to the first device side method embodiment, each implementation process and implementation of the method embodiment can be applied to the terminal embodiment, and a same technical effect can be achieved. Specifically, FIG. 19 is a schematic diagram of a hardware structure of a terminal according to an embodiment of this application.

The terminal 1900 includes but is not limited to at least a part of components such as a radio frequency unit 1901, a network module 1902, an audio output unit 1903, an input unit 1904, a sensor 1905, a display unit 1906, a user input unit 1907, an interface unit 1908, a memory 1909, and a processor 1910.

A person skilled in the art can understand that the terminal 1900 may further include a power supply (such as a battery) that supplies power to each component. The power supply may be logically connected to the processor 1910 by using a power supply management system, to implement functions such as charging and discharging management, and power consumption management by using the power supply management system. The terminal structure shown in FIG. 19 constitutes no limitation on the terminal, and the terminal may include more or fewer components than those shown in the figure, or combine some components, or have different component arrangements. Details are not described herein.

It should be understood that in this embodiment of this application, the input unit 1904 may include a Graphics Processing Unit (GPU) 19041 and a microphone 19042. The graphics processing unit 19041 processes image data of a static picture or a video obtained by an image capture apparatus (for example, a camera) in a video capture mode or an image capture mode. The display unit 1906 may include a display panel 19061, and the display panel 19061 may be configured in a form of a liquid crystal display, an organic light-emitting diode, or the like. The user input unit 1907 includes at least one of a touch panel 19071 and another input device 19072. The touch panel 19071 is also referred to as a touchscreen. The touch panel 19071 may include two parts: a touch detection apparatus and a touch controller. The another input device 19072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1901 may transmit the downlink data to the processor 1910 for processing. In addition, the radio frequency unit 1901 may send uplink data to the network side device. Generally, the radio frequency unit 1901 includes but is not limited to an antenna, an amplifier, a transceiver, a coupler, a low noise amplifier, a duplexer, and the like.

The memory 1909 may be configured to store a software program or an instruction and various data. The memory 1909 may mainly include a first storage area for storing a program or an instruction and a second storage area for storing data. The first storage area may store an operating system, and an application or an instruction required by at least one function (for example, a sound playing function or an image playing function). In addition, the memory 1909 may be a volatile memory or a non-volatile memory, or the memory 1909 may include a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1909 in this embodiment of this application includes but is not limited to these memories and any memory of another proper type.

The processor 1910 may include one or more processing units. Optionally, an application processor and a modem processor are integrated into the processor 1910. The application processor mainly processes an operating system, a user interface, an application, or the like. The modem processor mainly processes a wireless communication signal, for example, a baseband processor. It may be understood that, alternatively, the modem processor may not be integrated into the processor 1910.

The radio frequency unit 1901 is configured to receive parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain.

Optionally, the target domain includes the time domain, and an interval between two adjacent target resource units in time domain in each resource unit group meets a requirement for a maximum unambiguous measurement range of the Doppler or the speed.

Optionally, the target domain includes the frequency domain, and an interval between two adjacent target resource units in frequency domain in each resource unit group meets a requirement for a maximum unambiguous measurement range of the delay or the distance.

Optionally, a resource span of the M target resource units in target domain meets a resolution requirement for the sensing measurement quantity corresponding to the target domain.

Optionally, the target domain includes the time domain, and a resource span of the M target resource units in time domain meets a resolution requirement for the Doppler or the speed.

Optionally, the target domain includes the frequency domain, and a resource span of the M target resource units in frequency domain meets a resolution requirement for the delay or the distance.

Optionally, the target domain includes the time domain, and a ratio of a first parameter of a first side lobe to a first parameter of a main lobe of a time domain signal sequence of the first signal in first transform domain is less than a first preset threshold; and/or

the target domain includes the frequency domain, and a ratio of a second parameter of a second side lobe to a second parameter of a main lobe of a frequency domain signal sequence of the first signal in second transform domain is less than a second preset threshold, where

the first transform domain is a Doppler domain, the first side lobe is a side lobe with a maximum amplitude or power in Doppler domain, and the first parameter includes an amplitude or a power; and

the second transform domain is a delay domain, the second side lobe is a side lobe with a maximum amplitude or power in delay domain, and the second parameter includes an amplitude or a power.

Optionally, the parameter configuration information includes resource configuration information of one or more resource sets, each resource set includes at least one target resource unit, and the target resource includes the one or more resource sets.

Optionally, the resource configuration information of the one or more resource sets includes at least one of the following:

a start position of the one or more resource sets in target domain;

a span of the one or more resource sets in target domain;

a resource interval between target resource units in the one or more resource sets;

a quantity of target resource units in the one or more resource sets;

a density of target resource units in the one or more resource sets;

a repetition periodicity of a slot, in time domain, in which a target resource unit in the one or more resource sets is located;

a position of a target resource unit in a slot in which the target resource unit in the one or more resource sets is located;

a repetition periodicity of a resource block RB, in frequency domain, in which a target resource unit in the one or more resource sets is located;

a position of an RB, in frequency domain, in which a target resource unit in the one or more resource sets is located;

a position, in an RB, of a target resource unit in the one or more resource sets;

first indication information, where the first indication information is used to indicate that the target domain is the time domain and/or the frequency domain; and

second indication information, where the second indication information is used to indicate position distribution of target resource units in the one or more resource sets in target domain, where

the span of the resource set in target domain is a span between a 1^{st} resource unit and a last resource unit of the resource set in target domain.

Optionally, the parameter configuration information further includes at least one of the following:

a start position of the first signal in target domain;

a resource span of the first signal in target domain; and

a repetition periodicity of the first signal in time domain, where

the resource span of the first signal in target domain is a span of at least two resource blocks between a 1^{st} target resource unit and a last target resource unit in target domain.

Optionally, the second indication information includes at least one of the following:

a bitmap, where the bitmap includes L bits, and each bit corresponds to one resource unit; in a case that a value corresponding to the bit is a first value, the resource unit corresponding to the bit is a target resource unit allocated to the resource set, or in a case that a value corresponding to the bit is a second value, the resource unit corresponding to the bit is not a target resource unit allocated to the resource set; and L is a positive integer;

parameter information of a sub-block, where the parameter information of the sub-block includes at least one of position distribution information of a target resource unit in the sub-block, a quantity X of sub-blocks, a repetition periodicity of the sub-block, and a start position of a 1^{st} sub-block in X sub-blocks, and X is a positive integer; and

parameter information of a target formula, where the target formula is a formula used to calculate position information of the target resource unit in the resource set in target domain, the parameter information of the target formula includes at least one of a type of the target formula, a formula parameter of the target formula, and a calculation result that is obtained according to the target formula, and the calculation result is used to indicate the position information.

Optionally, the first signal is configured as single-port or multi-port;

in a case that the first signal is configured as multi-port, resources of first signals at different ports meet at least one of the following:

frequency division multiplexing;

time division multiplexing; and

the first signals at the different ports have a same resource pattern in target domain, and the first signals at the different ports use different generation sequences; or the first signals at the different ports have a same resource pattern in target domain, the first signals at the different ports use a same generation sequence, and different first signals correspond to different orthogonal cover codes.

Optionally, the radio frequency unit 1901 is further configured to:

send capability information, where the capability information is used to indicate whether the first device has a capability to process the first signal meeting the first feature.

Optionally, the radio frequency unit 1901 is further configured to:

perform a first operation on the first signal according to the parameter configuration information of the first signal, where the first operation includes at least one of sending, receiving, and signal processing.

Optionally, the radio frequency unit 1901 is further configured to:

obtain an activation instruction for the one or more resource sets, where the activation instruction is used to instruct the first device to perform a first operation on the first signal corresponding to the one or more resource sets, and the first operation includes at least one of sending, receiving, and signal processing.

Optionally, the radio frequency unit 1901 is further configured to:

obtain a deactivation instruction for the one or more resource sets, where the deactivation instruction is used to instruct the first device to stop performing the first operation on the first signal corresponding to the at least one or more resource sets, and the first operation includes at least one of sending, receiving, and signal processing.

In this embodiment of this application, the first device receives the parameter configuration information of the first signal, where the first signal is the integrated sensing and communication signal or the sensing signal, the resource pattern of the first signal meets the first feature, and the first feature is: including the target resource, where the target resource includes the M target resource units in target domain, the target resource corresponds to the at least two resource intervals in target domain, and the target resource unit is the resource unit allocated to the first signal; and the M target resource units in target domain include the N target resource unit groups, each target resource unit group includes the two adjacent target resource units in target domain in the M target resource units, and the interval between the two adjacent target resource units in target domain in each target resource unit group meets the requirement for the maximum unambiguous measurement range of the sensing measurement quantity corresponding to the target domain. The M target resource units correspond to the at least two resource intervals in target domain, and in the integrated sensing and communication scenario, according to the sensing requirement, a resource interval between some adjacent target resource units in target domain can be set as a resource interval meeting a resolution requirement for a corresponding sensing measurement quantity, while a resource interval between remaining adjacent target resource units in target domain is greater than the resource interval of the resolution requirement for the corresponding sensing measurement quantity. Therefore, resource overheads are reduced on the premise that the first signal can meet the sensing requirement.

An embodiment of this application further provides a network side device, including a processor and a communication interface. The communication interface is configured to receive or send parameter configuration information of a first signal, where the first signal is an integrated sensing and communication signal or a sensing signal, and the parameter configuration information is used to indicate a resource pattern of the first signal, where

the resource pattern of the first signal meets a first feature, and the first feature is:

including a target resource, where the target resource includes M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;

the M target resource units in target domain include N target resource unit groups, each target resource unit group includes two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;

the interval between the two adjacent target resource units in target domain includes at least one of the following: an interval between two adjacent target resource units in time domain, and an interval between two adjacent target resource units in frequency domain;

the sensing measurement quantity corresponding to the target domain includes Doppler, a speed, a delay, or a distance; and

the target domain includes at least one of the time domain and the frequency domain. The network side device embodiment corresponds to the first device or second device method embodiment, each implementation process and implementation of the method embodiment can be applied to the network side device embodiment, and a same technical effect can be achieved.

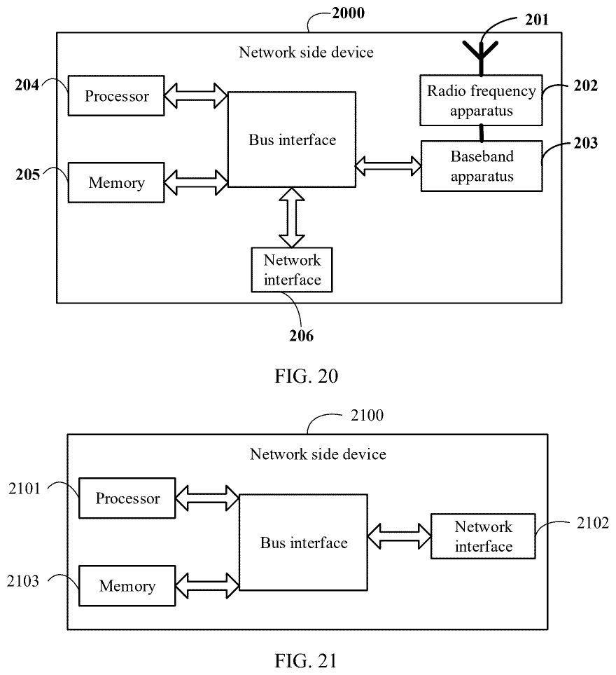

Specifically, an embodiment of this application further provides a network side device. As shown in FIG. 20, the network side device 2000 includes an antenna 201, a radio frequency apparatus 202, a baseband apparatus 203, a processor 204, and a memory 205. The antenna 201 is connected to the radio frequency apparatus 202. In an uplink direction, the radio frequency apparatus 202 receives information through the antenna 201, and sends the received information to the baseband apparatus 203 for processing. In a downlink direction, the baseband apparatus 203 processes information that needs to be sent, and sends processed information to the radio frequency apparatus 202. The radio frequency apparatus 202 processes the received information, and sends processed information through the antenna 201.

In the foregoing embodiment, the method performed by the first device or the second device may be implemented in the baseband apparatus 203. The baseband apparatus 203 includes a baseband processor.

For example, the baseband apparatus 203 may include at least one baseband board. A plurality of chips are disposed on the baseband board. As shown in FIG. 20, one chip is, for example, a baseband processor, and is connected to the memory 205 by using a bus interface, to invoke a program in the memory 205 to perform the operations of the network device shown in the foregoing method embodiment.

The network side device may further include a network interface 206, and the interface is, for example, a common public radio interface (CPRI).

Specifically, the network side device 2000 in this embodiment of this application further includes an instruction or a program that is stored in the memory 205 and that is executable on the processor 204. The processor 204 invokes the instruction or the program in the memory 205 to perform the method performed by the modules shown in FIG. 16 or 17, and a same technical effect is achieved. To avoid repetition, details are not described herein again.

Specifically, an embodiment of this application further provides a network side device. As shown in FIG. 21, a network side device 2100 includes a processor 2101, a network interface 2102, and a memory 2103. The network interface 2102 is, for example, a common public radio interface (CPRI).

Specifically, the network side device 2100 in this embodiment of this application further includes an instruction or a program that is stored in the memory 2103 and that is executable on the processor 2101. The processor 2101 invokes the instruction or the program in the memory 2103 to perform the method performed by the modules shown in FIG. 16 or 17, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing embodiment of the signal transmission method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the signal transmission method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the signal transmission method, and a same technical effect can be achieved. To avoid repetition, details are not described herein again.

An embodiment of this application further provides a signal transmission system, including a first device and a second device. The first device may be configured to perform the steps of the signal transmission method performed by the first device, and the second device may be configured to perform the steps of the signal transmission method performed by the second device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A signal transmission method, comprising:
receiving, by a first device, parameter configuration information of a first signal, wherein the first signal is an integrated sensing and communication signal or a sensing signal, and the parameter configuration information is used to indicate a resource pattern of the first signal, wherein
the resource pattern of the first signal meets a first feature, and the first feature is:
comprising a target resource, wherein the target resource comprises M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;
the M target resource units in target domain comprise N target resource unit groups, each target resource unit group comprises two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;
the interval between the two adjacent target resource units in target domain comprises at least one of the following: an interval between two adjacent target resource units in time domain, and an interval between two adjacent target resource units in frequency domain;
the sensing measurement quantity corresponding to the target domain comprises Doppler, a speed, a delay, or a distance; and
the target domain comprises at least one of the time domain and the frequency domain.

2. The method according to claim 1, wherein at least one of:
the target domain comprises the time domain, and an interval between two adjacent target resource units in time domain in each resource unit group meets a requirement for a maximum unambiguous measurement range of the Doppler or the speed; and
the target domain comprises the frequency domain, and an interval between two adjacent target resource units in frequency domain in each resource unit group meets a requirement for a maximum unambiguous measurement range of the delay or the distance.

3. The method according to claim 1, wherein a resource span of the M target resource units in target domain meets a resolution requirement for the sensing measurement quantity corresponding to the target domain.

4. The method according to claim 3, wherein target domain comprises the time domain, and a resource span of the M target resource units in time domain meets a resolution requirement for the Doppler or the speed; or
wherein target domain comprises the frequency domain, and a resource span of the M target resource units in frequency domain meets a resolution requirement for the delay or the distance.

5. The method according to claim 1, wherein target domain comprises the time domain, and a ratio of a first parameter of a first side lobe to a first parameter of a main lobe of a time domain signal sequence of the first signal in first transform domain is less than a first preset threshold; or
the target domain comprises the frequency domain, and a ratio of a second parameter of a second side lobe to a second parameter of a main lobe of a frequency domain signal sequence of the first signal in second transform domain is less than a second preset threshold, wherein
the first transform domain is a Doppler domain, the first side lobe is a side lobe with a maximum amplitude or power in Doppler domain, and the first parameter comprises an amplitude or a power; and
the second transform domain is a delay domain, the second side lobe is a side lobe with a maximum amplitude or power in delay domain, and the second parameter comprises an amplitude or a power.

6. The method according to claim 1, wherein the parameter configuration information comprises resource configuration information of one or more resource sets, each resource set comprises at least one target resource unit, and the target resource comprises the one or more resource sets.

7. The method according to claim 6, wherein the resource configuration information of the one or more resource sets comprises at least one of the following:
a start position of the one or more resource sets in target domain;
a span of the one or more resource sets in target domain;
a resource interval between target resource units in the one or more resource sets;
a quantity of target resource units in the one or more resource sets;
a density of target resource units in the one or more resource sets;
a repetition periodicity of a slot, in time domain, in which a target resource unit in the one or more resource sets is located;
a position of a target resource unit in a slot in which the target resource unit in the one or more resource sets is located;
a repetition periodicity of a resource block RB, in frequency domain, in which a target resource unit in the one or more resource sets is located;
a position of an RB, in frequency domain, in which a target resource unit in the one or more resource sets is located;
a position, in an RB, of a target resource unit in the one or more resource sets;
first indication information, wherein the first indication information is used to indicate that the target domain is the time domain or the frequency domain; and
second indication information, wherein the second indication information is used to indicate position distribution of target resource units in the one or more resource sets in target domain, wherein
the span of the resource set in target domain is a span between a 1^{st} resource unit and a last resource unit of the resource set in target domain.

8. The method according to claim 6, wherein the parameter configuration information further comprises at least one of the following:
a start position of the first signal in target domain;
a resource span of the first signal in target domain; and
a repetition periodicity of the first signal in time domain, wherein
the resource span of the first signal in target domain is a span of at least two resource blocks between a 1^{st} target resource unit and a last target resource unit in target domain.

9. The method according to claim 7, wherein the second indication information comprises at least one of the followings:
a bitmap, wherein the bitmap comprises L bits, and each bit corresponds to one resource unit; in a case that a value corresponding to the bit is a first value, the resource unit corresponding to the bit is a target resource unit allocated to the resource set, or in a case that a value corresponding to the bit is a second value, the resource unit corresponding to the bit is not a target resource unit allocated to the resource set; and L is a positive integer;
parameter information of a sub-block, wherein the parameter information of the sub-block comprises at least one of position distribution information of a target resource unit in the sub-block, a quantity X of sub-blocks, a repetition periodicity of the sub-block, and a start position of a 1^{st} sub-block in X sub-blocks, and X is a positive integer; and
parameter information of a target formula, wherein the target formula is a formula used to calculate position information of the target resource unit in the resource set in target domain, the parameter information of the target formula comprises at least one of a type of the target formula, a formula parameter of the target formula, and a calculation result that is obtained according to the target formula, and the calculation result is used to indicate the position information.

10. The method according to claim 6, further comprising:
obtaining, by the first device, an activation instruction or a deactivation instruction for the one or more resource sets, wherein the activation instruction is used to instruct the first device to perform a first operation on the first signal corresponding to the one or more resource sets, and the first operation comprises at least one of sending, receiving, and signal processing, wherein the deactivation instruction is used to instruct the first device to stop performing the first operation on the first signal corresponding to the at least one or more resource sets, and the first operation comprises at least one of sending, receiving, and signal processing.

11. The method according to claim 1, wherein the first signal is configured as single-port or multi-port;
in a case that the first signal is configured as multi-port, resources of first signals at different ports meet at least one of the following:
frequency division multiplexing;
time division multiplexing; and
the first signals at the different ports have a same resource pattern in target domain, and the first signals at the different ports use different generation sequences; or the first signals at the different ports have a same resource pattern in target domain, the first signals at the different ports use a same generation sequence, and different first signals correspond to different orthogonal cover codes.

12. The method according to claim 1, the method further comprises:
sending, by the first device, capability information, wherein the capability information is used to indicate whether the first device has a capability to process the first signal meeting the first feature.

13. The method according to claim 1, further comprising:
performing, by the first device, a first operation on the first signal according to the parameter configuration information of the first signal, wherein the first operation comprises at least one of sending, receiving, and signal processing.

14. A signal transmission method, comprising:
sending, by a second device, parameter configuration information of a first signal, wherein the first signal is an integrated sensing and communication signal or a sensing signal, and the parameter configuration information is used to indicate a resource pattern of the first signal, wherein
the resource pattern of the first signal meets a first feature, and the first feature is:
comprising a target resource, wherein the target resource comprises M target resource units in target domain, the target resource corresponds to at least two resource intervals in target domain, the target resource unit is a resource unit allocated to the first signal, M≥3, M is a positive integer, and the resource interval is an interval between two adjacent target resource units in target domain in the target resource;
the M target resource units in target domain comprise N target resource unit groups, each target resource unit group comprises two adjacent target resource units in target domain in the M target resource units, an interval between the two adjacent target resource units in target domain in each target resource unit group meets a requirement for a maximum unambiguous measurement range of a sensing measurement quantity corresponding to the target domain, and N is greater than or equal to a first preset value;
the interval between the two adjacent target resource units in target domain comprises at least one of the following: an interval between two adjacent target resource units in time domain, and an interval between two adjacent target resource units in frequency domain;
the sensing measurement quantity corresponding to the target domain comprises Doppler, a speed, a delay, or a distance; and
the target domain comprises at least one of the time domain and the frequency domain.

15. The method according to claim 14, further comprising:
obtaining, by the second device, capability information sent by a first device, wherein the capability information is used to indicate whether the first device has a capability to process the first signal meeting the first feature.

16. The method according to claim 15, further comprising:
performing, by the second device, a first operation on the first signal according to the parameter configuration information of the first signal, wherein the first operation comprises at least one of sending, receiving, and signal processing.

17. The method according to claim 15, wherein the parameter configuration information comprises resource configuration information of one or more resource sets, each resource set comprises at least one target resource unit, and the one or more resource sets constitute the M target resource units.

18. The method according to claim 17, further comprising:
sending, by the second device, an activation instruction or a deactivation instruction for the one or more resource sets, wherein the activation instruction is used to instruct the first device to perform a first operation on the first signal corresponding to the one or more resource sets, and the first operation comprises at least one of sending, receiving, and signal processing, and wherein the deactivation instruction is used to instruct the first device to stop performing the first operation on the first signal corresponding to the at least one or more resource sets, and the first operation comprises at least one of sending, receiving, and signal processing.

19. A communication device, comprising at least one hardware processor and a memory, wherein the memory stores a program or an instruction that is executable by the at least one hardware processor that, when executed by the at least one hardware processor, directs the at least one hardware processor to implement the signal transmission method according to claim 1

20. A communication device, comprising at least one hardware processor and a memory, wherein the memory stores a program or an instruction that is executable by the at least one hardware processor that, when executed by the at least one hardware processor, directs the at least one hardware processor to implement the signal transmission method according to claim 15.
